(19) United States
(12) Patent Application Publication
(10) Pub. No.: US 2024/0151683 A1
(43) Pub. Date: May 9, 2024

(54) REDOX-RESPONSIVE HALOGEN BONDING POLYMERS FOR SELECTIVE ELECTROCHEMICAL SEPARATION

(71) Applicant: THE BOARD OF TRUSTEES OF THE UNIVERSITY OF ILLINOIS, Urbana, IL (US)

(72) Inventors: Xiao SU, Champaign, IL (US); Nayeong KIM, Champaign, IL (US); Johannes ELBERT, Urbana, IL (US)

(21) Appl. No.: 18/382,796

(22) Filed: Oct. 23, 2023

Related U.S. Application Data
(60) Provisional application No. 63/418,615, filed on Oct. 23, 2022.

(51) Int. Cl. G01N 27/333; C08F 130/04

(52) U.S. Cl. CPC G01N 27/333; C08F 130/04

(57) ABSTRACT

The design of electrochemically responsive halogen donors in redox-active polymer for switchable electrosorption and release of anions. A redox-active group such as ferrocene acts as an electron-withdrawing group, facilitating the delocalization of the electrons on the halogen atom. Upon the oxidation of the ferrocene moiety, the halogen atom forms a partial-positive charge (σ-hole) on the elongation of the C—I bond, resulting in strong binding with anions in cooperation with the hydrogen bonds on the cyclopentadienyl ring on the oxidized ferrocene. During reduction of ferrocene, halogen bonding is deactivated, releasing the bound anions reversibly.

### RELATED APPLICATIONS

This application claims priority under 35 U.S.C. § 119(e) to U.S. Provisional Patent Application No. 63/418,615 filed Oct. 23, 2022, which is incorporated herein by reference.

### GOVERNMENT SUPPORT

This invention was made with government support under Grant No. 1942971 awarded by the National Science Foundation. The government has certain rights in the invention.

### BACKGROUND OF THE INVENTION

The design of molecularly selective interactions with strong binding and reversibility is of paramount importance for electrochemically-mediated separations in a heterogeneous platform, particularly for the sustainable recovery of value-added species in organic media. Redox-active platforms have been powerful for the selective recovery of value-added species; however, their applications have primarily been restricted to ion sorption applications in the aqueous phase, where selective electrosorption has mostly relied on electrostatic interactions between the redox-active motif and ions. With the growing industries of pharmaceutical or chemical synthesis, the discovery, development, and implementation of new, tunable intermolecular interactions are essential to expanding the scope of selective electrochemical separation to non-aqueous media. Here, we design a redox-responsive halogen bonding polymer for the first time as a highly selective, non-covalent interaction for electrochemical separations in non-aqueous media. Our study demonstrates the use of halogen bonding for achieving the selective electrosorption and release of target species via the electrochemical amplification of its intermolecular interaction with a cooperative, synergistic redox-center.

Halogen bonding (XB) has emerged as a versatile noncovalent interaction for a wide range of anions, especially halide molecules, which has been applied as an electrochemical sensor in organic media (European Journal of Inorganic Chemistry 2017, 2017, 220). XB offers stronger non-covalent interactions towards Lewis bases than hydrogen bonding in organic media, owing to the highly polarizable nature of the halide donor atom. Thus, the importance of the XB can be found in numerous applications such as the self-assembly of crystal formation, sensors, catalysis, enantiomer separations, and drug encapsulations (Coordination Chemistry Reviews 2020, 416, 213281). With the various applications, XB molecules have also been diverse in various structural forms such as monomers, crystals, oligomers, and polymeric structures (Chemical Science 2021, 12, 9275) in both homogeneous and thin film. In addition, XB has been a key interaction in biological systems, such as between the thyroid and its enzyme (iodothyronine deiodinases) to control protein synthesis and bone maturation. The design of redox-responsive motifs with XB donors has been previously explored as an electrochemical sensor by incorporating redox-active units such as ferrocene and tetrathiafulvalene as electron-withdrawing groups to modulate the strength of the halogen bonding (Current Opinion in Electrochemistry 2019, 15, 89). Upon the oxidation of redox-active moiety, it withdraws electron density from the halogen atom, thus forming a lower electron density region, known as σ-hole, and achieving strong molecular recognition towards the anions.

Despite its promising switchability and directional selectivity for ion binding, halogen bonding has not yet been explored for electrochemically-mediated electrosorption. Redox-mediated anion recognition studies have mainly focused on homogeneous sensing systems, where both the target species and redox-active molecules are dissolved in organic media. However, for electrosorption, a heterogeneous platform is necessary to easily separate the adsorbed target species and XB donor molecules from the initial solution. Although redox-responsive self-assembled monolayers (SAMs) have been extensively studied for surface-confined sensors with their enhanced sensing recognition and faster response, their limited loading capacity of XB donors makes them challenging to implement in electrosorption for the uptake of bulk target species in solution. Therefore, tailored molecular architecture design is essential to integrating current state-of-the-art redox-responsive halogen bonding donors into selective electrosorption.

Accordingly, there is a need for improved methods to sense and separate targeted anionic species from mixtures.

### SUMMARY

We demonstrate the redox-switchable halogen bonding for anion recognition and electrosorption of a series of halides and oxyanions, and even organic molecules, highlighting the remarkable selectivity and reversibility of P(FcTS-I) in the heterogeneous platform. To provide evidence of molecular interaction between σ-hole and target species, NMR and Raman spectroscopy measurements were conducted in reduced and oxidized states of the redox-active motif. In addition, density functional theory (DFT) calculations offer insights into the molecular-level σ-hole amplification and highlight the significance of directional intermolecular interactions in promoting the selective binding of XB donor molecules. Overall, the cooperative molecular design of the redox-center with the XB donor enables non-aqueous electrosorption through the highly directional non-covalent interaction, offering a unique strategy to control the binding selectivity and reversibility towards electrochemical separations.

Accordingly, this disclosure provides a metallopolymer comprising formula I:

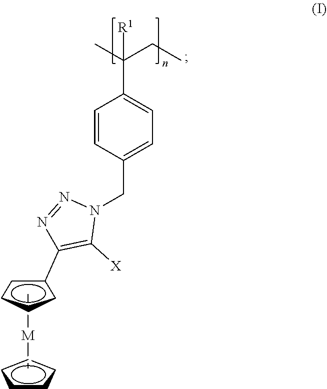

wherein,

M is a transition metal or transition metal ion;

R¹ is H or —(C₁-C₆)alkyl;

X is halo (halide) or hydrogen (H); and

n is an integer from about 10 to about 100,000; and

wherein the metallopolymer is redox-active.

This disclosure also provides a redox electrode comprising a metallopolymer described above, a carbon allotrope, and a crosslinker.

Additionally, this disclosure provides an electrochemical method for sensing or separating anions, comprising:
a) contacting a solution comprising a suitable solvent, a mixture of anions, and a redox electrode described above;
b) applying a voltage potential to the redox electrode wherein the voltage potential is applied under suitable conditions for chronoamperometry or voltammetry;
c1) sensing a target anion in the mixture via a change in voltage, current, or impedance relative to a reference electrode; and/or
c2) separating from the mixture a target anion;

wherein the redox electrode selectively binds to a target anion in the mixture thereby sensing the target anion in the mixture, separating the target anion from the mixture, or both.

The invention provides novel polymers of formula I/IA, intermediates and monomers for the synthesis of polymers of formula I/IA, as well as methods of preparing polymers of formula I/IA. The invention also provides polymers of formula I/IA that are useful as intermediates for the synthesis of other useful polymers. This invention also provides novel monomers that are useful for preparing any of the polymer described herein or other types of polymers.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1A-M. Synthesis of (a) redox-active halogen bonding donor (FcTS-I) and (b) hydrogen bonding donor (FcTS) and their polymer. (c) ¹H-NMR (C₃D₇NO, 500 MHz) and (d) ¹³C-NMR (C₃D₇NO, 125 MHz) spectra of FcTS-I and FcTS. High-resolution SEM images, and EDS mapping of (e) P(FcTS-I), (f) P(FcTS), and (g) PVF electrodes. 20 cycles of cyclic voltammograms (CV) of (h) P(FcTS-I), (i) P(FcTS), and (j) PVF electrodes in 100 mM TBAPF₆ at a scan rate of 30 mV/s in acetonitrile with activated carbon clothes (ACC) as a counter and Ag/AgNO₃ as a reference electrode. Electrochemical responses of (k) P(FcTS-I) redox-reaction and creation of sigma hole and (l) PVF redox-reaction. (m) Illustration of P(FcTS-I) electrochemical responses during the electrosorption, where the oxidation of ferrocene amplifies a sigma hole for the electrosorption and desorption, where the reduction of ferrocene switches off the halogen bonding and release the adsorbed anions.

FIG. 2A-H. Sensing recognition studies in response to the various (a) halides and (b) oxyanions. ΔE_{1/2} was calculated by the E_{1/2} peak shift in CV after the addition of 10 mM of target anions at a scan rate of 30 mV/s. Electrosorption studies for (c) chloride and (d) bisulfate at open-circuit potential (OCP) and +0.3 V vs E_{1/2} with P(FcTS-I), P(FcTS), and PVF in 1 mM of target anions (in TBA form) and 10 mM TBAPF₆ for 15 min, while desorption was performed at OCP or −0.3 V vs E_{1/2} in 20 mM TBABF₄ for 15 min. (e) Binding energies (ΔG) of Cl⁻ and HSO₄⁻ to oxidized P(FcTS-I), P(FcTS), and PVF in acetonitrile solvent calculated by the qRRHO-G method with the 100 cm⁻¹ cutoff. (f) Energy decomposition of [FcTS-I]⁺—Cl⁻ and [FcTS]⁺—Cl⁻, where ECT (orange), E_{disp} (yellow), Eₚₒₗₐᵣ (white), and E_{sol+elec+Pauli} (green) represent charge transfer, dispersion, polarization, and solvation+electrostatic+Pauli repulsion energies, respectively. Illustrations of optimized structures of (g) [FcTS-I]⁺—Cl⁻ and [FcTS]⁺—Cl⁻ and (h) [FcTS-I]⁺—HSO₄⁻ and [FcTS]⁺—HSO₄⁻ at the ωB97X-D3(BJ)/ma-def2-TZVP level of theory in acetonitrile, where atoms are shown using the ball and stick model with C in grey, H in white, N in blue, Fe in orange, Cl in green, O in red, and S in yellow.

FIG. 3A-E. (a) Molecular electrostatic potential surface (ESP) mapping at an isovalue of 0.3 a.u. for reduced (top) and oxidized (bottom) states of P(FcTS-I), P(FcTS), and PVF. ESP was generated using the mapped vdW spheres with the scale value of 0.85 and the potential between 80 and 190 kcal/mol. ¹³C-NMR (C₃D₇NO, 125 MHz) spectra of (b) FcTS-I and (c) FcTS in the presence of 0 and 1 equivalent of TBACl. Ex-situ Raman spectra of (d) FcTS-I, FcTS, and vinyl ferrocene, and (f) reduced and oxidized FcTS-I in the presence of 10 mM Cl⁻, and oxidized FcTS-I in the presence of 10 mM of PF₆⁻. The electrochemical oxidation for ex-situ Raman was done in a homogeneous phase, dissolving 5 mM FcTS-I in acetonitrile and applying 0.3 V vs E_{1/2} for 30 min.

FIG. 4A-D. (a) Chloride recognition with respect to the addition of ethanol in the solvent. (b) Sensing capability towards chloride and bisulfate in acetonitrile (shaded) and in 10:90 vol % of ethanol:acetonitrile (colored). Chloride and bisulfate uptakes (c) in acetonitrile and (d) in 10:90 vol % of ethanol:acetonitrile. The electrosorption was carried out at +0.3 V vs E1/2 in 5 mM Cl⁻ and 5 mM HSO₄⁻ for 15 min. The selectivity was calculated by α_{cl-}=(Cl⁻_{,ads}/HSO₄⁻_{,ads})/(Cl⁻_{,sol}/HSO₄⁻_{,sol}) in mol.

FIG. 5A-D. The adsorption capacity of (a) benzenesulfonate (Ph-SO₃⁻) and (b) phenyl phosphonate (Ph-HPO₃⁻) at various electrosorption potentials from open-circuit potential (OCP) to ±0.8 V vs E_{1/2}. The adsorption capacity of (c) benzenesulfonic acid (Ph-SO₃⁻) and (d) phenyl phosphonic acid (Ph-HPO₃⁻) with P(FcTS-I), P(FcTS), and PVF at ±0.8 V vs E_{1/2}. The adsorption was performed in 1 mM of Ph-HSO₃ and Ph-H₂PO₃ and 10 mM TBAPF₆ as a supporting salt for 15 min, while desorption was performed in 20 mM TBABF₄ for 15 min.

FIG. 6. Molecular weight distributions obtained by Gel permeation chromatography (GPC) for (a) P(FcTS-I) and (b) P(FcTS) relative to poly(methyl methacrylate), (c) PVF (absolute molecular weight using MALLS). The absolute molecular weight of PVF is 1,500 Da, Mw is 3,200 Da, and B is 2.22.

FIG. 7. FTIR spectra of (a) FcTS-I and P(FcTS-I), (b) FcTS and P(FcTS), and (c) vinyl ferrocene and PVF.

FIG. 8. Thermogravimetric Analysis (TGA) of P(FcTS-I), P(FcTS), and PVF. TGA profiles demonstrate notable thermal stability of P(FcTS-I), P(FcTS), and PVF, particularly at temperatures below 210° C. Hence, the synthesis of electrodes using a cross-linker at 140° C. does not lead to any polymer degradation.

FIG. 9. X-ray photoelectron spectroscopy of heterogeneous electrodes for P(FcTS-I), P(FcTS), and PVF: (a) 1Cs, (b) N1s, (c) Fe2p, and (d) I3d.

### DETAILED DESCRIPTION

The development of redox-responsive material platforms with electrochemically tunable intermolecular interactions is key to achieving efficient and selective electrochemical separations. Through a combination of synthesis, spectroscopy, and electronic structure calculations, we explore for the first time redox-responsive halogen bonding (XB) materials for selective electrosorption in non-aqueous media, by taking advantage of directional interactions of XB with cooperative, synergistic redox-center. We design and evaluate a new redox-active XB donor polymer, poly(5-iodo-4-ferrocenyl-1-(4-vinylbenzyl)-1H-1,2,3-triazole) (P(FcTS-I)) for the electrochemically switchable binding and release of target organic and inorganic ions at a heterogeneous interface through halogen-bonding. Under applied potential, oxidized ferrocene amplifies the halogen binding site, leading to notable uptake and selectivity of key inorganic anions like chloride and bisulfate, compared to open-circuit potential, or even hydrogen bonding donor analog, and unfunctionalized poly(vinyl ferrocene). Furthermore, we show the highly favorable interaction between P(FcTS-I) and organic species such as benzenesulfonate, providing insights into potential applications of the redox-responsive XB in the recovery of value-added organic molecules. The downfield shift of the ¹³C-NMR signal and C—I bond stretch in Raman spectroscopy provides evidence that the strong partial positive site (σ-hole) on the halide acts as a main binding site, while the adjacent ferrocenium motif contributes to secondary binding sites. Density functional theory calculations offer mechanistic insight into the degree of amplification of σ-hole at a molecular level, with selectivity modulated by charge transfer and dispersion interactions between iodine on P(FcTS-I) and target species. Our work highlights the potential of XB in selective electrosorption, by uniquely leveraging non-covalent interactions for redox-mediated electrochemical separations.

### Definitions

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14^{th} Edition, by R. J. Lewis, John Wiley & Sons, New York, N.Y., 2001.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit. For example, one or more substituents on a phenyl ring refers to one to five, or one to four, for example if the phenyl ring is disubstituted.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability resulting from the standard deviations found in their respective testing measurements. When values are expressed as approximations, by use of the antecedent “about,” it will be understood that the particular value without the modifier “about” also forms a further aspect.

The terms “about” and “approximately” are used interchangeably. Both terms can refer to a variation of ±5%, ±10%, ±20%, or ±25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the terms “about” and “approximately” are intended to include values, e.g., weight percentages, proximate to the recited range that are equivalent in terms of the functionality of the individual ingredient, composition, or embodiment. The terms “about” and “approximately” can also modify the endpoints of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units are also disclosed. For example, if 10 to 15 is disclosed, then 11, 12, 13, and 14 are also disclosed, individually, and as part of a range. A recited range (e.g., weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

This disclosure provides ranges, limits, and deviations to variables such as volume, mass, percentages, ratios, etc. It is understood by an ordinary person skilled in the art that a range, such as “numberl” to “number2”, implies a continuous range of numbers that includes the whole numbers and fractional numbers. For example, 1 to 10 means 1, 2, 3, 4, 5, . . . 9, 10. It also means 1.0, 1.1, 1.2. 1.3, . . . , 9.8, 9.9, 10.0, and also means 1.01, 1.02, 1.03, and so on. If the variable disclosed is a number less than “number10”, it implies a continuous range that includes whole numbers and fractional numbers less than number10, as discussed above. Similarly, if the variable disclosed is a number greater than “number10”, it implies a continuous range that includes whole numbers and fractional numbers greater than number10. These ranges can be modified by the term “about”, whose meaning has been described above.

The recitation of a), b), c), . . . or i), ii), iii), or the like in a list of components or steps do not confer any particular order unless explicitly stated.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “contacting” refers to the act of touching, making contact, or of bringing to immediate or close proximity, including at the cellular or molecular level, for example, to bring about a chemical reaction or a physical change, e.g., in a solution, in a reaction mixture.

The term “substantially” as used herein, is a broad term and is used in its ordinary sense, including, without limitation, being largely but not necessarily wholly that which is specified. For example, the term could refer to a numerical value that may not be 100% the full numerical value. The full numerical value may be less by about 1%, about 2%, about 3%, about 4%, about 5%, about 6%, about 7%, about 8%, about 9%, about 10%, about 15%, or about 20%.

Wherever the term “comprising” is used herein, options are contemplated wherein the terms “consisting of” or “consisting essentially of” are used instead. As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the aspect element. As used herein, “consisting essentially of” does not exclude materials or steps that do not materially affect the basic and novel characteristics of the aspect. In each instance herein any of the terms “comprising”, “consisting essentially of” and “consisting of” may be replaced with either of the other two terms. The disclosure illustratively described herein may be suitably practiced in the absence of any element or elements, limitation or limitations which is not specifically disclosed herein.

This disclosure provides methods of making the compounds and compositions of the invention. The compounds and compositions can be prepared by any of the applicable techniques described herein, optionally in combination with standard techniques of organic synthesis. Many techniques such as etherification and esterification are well known in the art. However, many of these techniques are elaborated in Compendium of Organic Synthetic Methods (John Wiley & Sons, New York), Vol. 1, Ian T. Harrison and Shuyen Harrison, 1971; Vol. 2, Ian T. Harrison and Shuyen Harrison, 1974; Vol. 3, Louis S. Hegedus and Leroy Wade, 1977; Vol. 4, Leroy G. Wade, Jr., 1980; Vol. 5, Leroy G. Wade, Jr., 1984; and Vol. 6; as well as standard organic reference texts such as March's Advanced Organic Chemistry: Reactions, Mechanisms, and Structure, 5th Ed., by M. B. Smith and J. March (John Wiley & Sons, New York, 2001); Comprehensive Organic Synthesis. Selectivity, Strategy & Efficiency in Modern Organic Chemistry. In 9 Volumes, Barry M. Trost, Editor-in-Chief (Pergamon Press, New York, 1993 printing); Advanced Organic Chemistry, Part B: Reactions and Synthesis, Second Edition, Cary and Sundberg (1983); for heterocyclic synthesis see Hermanson, Greg T., Bioconjugate Techniques, Third Edition, Academic Press, 2013.

The formulas and compounds described herein can be modified using protecting groups. Suitable amino and carboxy protecting groups are known to those skilled in the art (see for example, Protecting Groups in Organic Synthesis, Second Edition, Greene, T. W., and Wutz, P. G. M., John Wiley & Sons, New York, and references cited therein; Philip J. Kocienski; Protecting Groups (Georg Thieme Verlag Stuttgart, New York, 1994), and references cited therein); and Comprehensive Organic Transformations, Larock, R. C., Second Edition, John Wiley & Sons, New York (1999), and referenced cited therein.

The term “halo” or “halide” refers to fluoro, chloro, bromo, or iodo. Similarly, the term “halogen” refers to fluorine, chlorine, bromine, and iodine.

The term “alkyl” refers to a branched or unbranched hydrocarbon having, for example, from 1-20 carbon atoms, and often 1-12, 1-10, 1-8, 1-6, or 1-4 carbon atoms; or for example, a range between 1-20 carbon atoms, such as 2-6, 3-6, 2-8, or 3-8 carbon atoms. As used herein, the term “alkyl” also encompasses a “cycloalkyl”, defined below. Examples include, but are not limited to, methyl, ethyl, 1-propyl, 2-propyl (iso-propyl), 1-butyl, 2-methyl-1-propyl (isobutyl), 2-butyl (sec-butyl), 2-methyl-2-propyl (t-butyl), 1-pentyl, 2-pentyl, 3-pentyl, 2-methyl-2-butyl, 3-methyl-2-butyl, 3-methyl-1-butyl, 2-methyl-1-butyl, 1-hexyl, 2-hexyl, 3-hexyl, 2-methyl-2-pentyl, 3-methyl-2-pentyl, 4-methyl-2-pentyl, 3-methyl-3-pentyl, 2-methyl-3-pentyl, 2,3-dimethyl-2-butyl, 3,3-dimethyl-2-butyl, hexyl, octyl, decyl, dodecyl, and the like. The alkyl can be unsubstituted or substituted, for example, with a substituent described below or otherwise described herein. The alkyl can also be optionally partially or fully unsaturated. As such, the recitation of an alkyl group can include an alkenyl group or an alkynyl group. The alkyl can be a monovalent hydrocarbon radical, as described and exemplified above, or it can be a divalent hydrocarbon radical (i.e., an alkylene).

An alkylene is an alkyl group having two free valences at a carbon atom or two different carbon atoms of a carbon chain. Similarly, alkenylene and alkynylene are respectively an alkene and an alkyne having two free valences at two different carbon atoms, or an alkenylene can have the two free valences on the same carbon.

The term “cycloalkyl” refers to cyclic alkyl groups of, for example, from 3 to 10 carbon atoms having a single cyclic ring or multiple condensed rings. Cycloalkyl groups include, by way of example, single ring structures such as cyclopropyl, cyclobutyl, cyclopentyl, cyclooctyl, and the like, or multiple ring structures such as adamantyl, and the like. The cycloalkyl can be unsubstituted or substituted. The cycloalkyl group can be monovalent or divalent and can be optionally substituted as described for alkyl groups. The cycloalkyl group can optionally include one or more cites of unsaturation, for example, the cycloalkyl group can include one or more carbon-carbon double bonds, such as, for example, 1-cyclopent-1-enyl, 1-cyclopent-2-enyl, 1-cyclopent-3-enyl, cyclohexyl, 1-cyclohex-1-enyl, 1-cyclohex-2-enyl, 1-cyclohex-3-enyl, and the like.

The term “heteroatom” refers to any atom in the periodic table that is not carbon or hydrogen. Typically, a heteroatom is O, S, N, P. The heteroatom may also be a halogen, metal or metalloid.

The term “heterocycloalkyl” or “heterocyclyl” refers to a saturated or partially saturated monocyclic, bicyclic, or polycyclic ring containing at least one heteroatom selected from nitrogen, sulfur, oxygen, preferably from 1 to 3 heteroatoms in at least one ring. Each ring is preferably from 3- to 10-membered, more preferably 4 to 7 membered. Examples of suitable heterocycloalkyl substituents include pyrrolidyl, tetrahydrofuryl, tetrahydrothiofuranyl, piperidyl, piperazyl, tetrahydropyranyl, morpholino, 1,3-diazapane, 1,4-diazapane, 1,4-oxazepane, and 1,4-oxathiapane. The group may be a terminal group or a bridging group.

The term “aryl” refers to an aromatic hydrocarbon group derived from the removal of at least one hydrogen atom from a single carbon atom of a parent aromatic ring system. The radical attachment site can be at a saturated or unsaturated carbon atom of the parent ring system. The aryl group can have from 6 to 30 carbon atoms, for example, about 6-10 carbon atoms. The aryl group can have a single ring (e.g., phenyl) or multiple condensed (fused) rings, wherein at least one ring is aromatic (e.g., naphthyl, dihydrophenanthrenyl, fluorenyl, or anthryl). Typical aryl groups include, but are not limited to, radicals derived from benzene, naphthalene, anthracene, biphenyl, and the like. The aryl can be unsubstituted or optionally substituted with a substituent described below. For example, a phenyl moiety or group may be substituted with one or more substituents R^{X} where R^{X} is at the ortho-, meta-, or para-position, and X is an integer variable of 1 to 5.

The term “heteroaryl” refers to a monocyclic, bicyclic, or tricyclic ring system containing one, two, or three aromatic rings and containing at least one nitrogen, oxygen, or sulfur atom in an aromatic ring. The heteroaryl can be unsubstituted or substituted, for example, with one or more, and in particular one to three, substituents, as described in the definition of “substituted”. Typical heteroaryl groups contain 2-20 carbon atoms in the ring skeleton in addition to the one or more heteroatoms, wherein the ring skeleton comprises a 5-membered ring, a 6-membered ring, two 5-membered rings, two 6-membered rings, or a 5-membered ring fused to a 6-membered ring. Examples of heteroaryl groups include, but are not limited to, 2H-pyrrolyl, 3H-indolyl, 4H-quinolizinyl, acridinyl, benzo[b]thienyl, benzothiazolyl,β-carbolinyl, carbazolyl, chromenyl, cinnolinyl, dibenzo[b,d]furanyl, furazanyl, furyl, imidazolyl, imidizolyl, indazolyl, indolisinyl, indolyl, isobenzofuranyl, isoindolyl, isoquinolyl, isothiazolyl, isoxazolyl, naphthyridinyl, oxazolyl, perimidinyl, phenanthridinyl, phenanthrolinyl, phenarsazinyl, phenazinyl, phenothiazinyl, phenoxathiinyl, phenoxazinyl, phthalazinyl, pteridinyl, purinyl, pyranyl, pyrazinyl, pyrazolyl, pyridazinyl, pyridyl, pyrimidinyl, pyrrolyl, quinazolinyl, quinolyl, quinoxalinyl, thiadiazolyl, thianthrenyl, thiazolyl, thienyl, triazolyl, tetrazolyl, and xanthenyl. In one embodiment the term “heteroaryl” denotes a monocyclic aromatic ring containing five or six ring atoms containing carbon and 1, 2, 3, or 4 heteroatoms independently selected from non-peroxide oxygen, sulfur, and N(Z) wherein Z is absent or is H, O, alkyl, aryl, or (C₁-C₆)alkylaryl. In some embodiments, heteroaryl denotes an ortho-fused bicyclic heterocycle of about eight to ten ring atoms derived therefrom, particularly a benz-derivative or one derived by fusing a propylene, trimethylene, or tetramethylene diradical thereto.

As used herein, the term “substituted” or “substituent” is intended to indicate that one or more (for example, in various embodiments, 1-10; in other embodiments, 1-6; in some embodiments 1, 2, 3, 4, or 5; in certain embodiments, 1, 2, or 3; and in other embodiments, 1 or 2) hydrogens on the group indicated in the expression using “substituted” (or “substituent”) is replaced with a selection from the indicated group(s), or with a suitable group known to those of skill in the art, provided that the indicated atom's normal valency is not exceeded, and that the substitution results in a stable compound. Suitable indicated groups include, e.g., alkyl, alkenyl, alkynyl, alkoxy, haloalkyl, hydroxyalkyl, aryl, heteroaryl, heterocyclyl, cycloalkyl, alkanoyl, alkoxycarbonyl, amino, alkylamino, dialkylamino, carboxyalkyl, alkylthio, alkylsulfinyl, and alkyl sulfonyl. Substituents of the indicated groups can be those recited in a specific list of substituents described herein, or as one of skill in the art would recognize, can be one or more substituents selected from alkyl, alkenyl, alkynyl, alkoxy, halo, haloalkyl, hydroxy, hydroxyalkyl, aryl, heteroaryl, heterocycle, cycloalkyl, alkanoyl, alkoxycarbonyl, amino, alkylamino, dialkylamino, trifluoromethylthio, difluoromethyl, acylamino, nitro, trifluoromethyl, trifluoromethoxy, carboxy, carboxyalkyl, keto, thioxo, alkylthio, alkylsulfinyl, alkylsulfonyl, and cyano. Suitable substituents of indicated groups can be bonded to a substituted carbon atom include F, Cl, Br, I, OR′, OC(O)N(R′)₂, CN, CF₃, OCF₃, R′, O, S, C(O), S(O), methylenedioxy, ethylenedioxy, N(R′)₂, SR′, SOR′, SO₂R′, SO₂N(R′)₂, SO₃R′, C(O)R′, C(O)C(O)R′, C(O)CH₂C(O)R′, C(S)R′, C(O)OR′, OC(O)R′, C(O)N(R′)₂, OC(O)N(R′)₂, C(S)N(R′)₂, (CH₂)₀₋₂NHC(O)R′, N(R′)N(R′)C(O)R′, N(R′)N(R′)C(O)OR′, N(R′)N(R′)CON(R′)₂, N(R′)SO₂R′, N(R′)SO₂N(R′)₂, N(R′)C(O)OR′, N(R′)C(O)R′, N(R′)C(S)R′, N(R′)C(O)N(R′)₂, N(R′)C(S)N(R′)₂, N(COR′)COR′, N(OR′)R′, C(═NH)N(R′)₂, C(O)N(OR′)R′, or C(═NOR′)R′ wherein R′ can be hydrogen or a carbon-based moiety (e.g., (C₁-C₆)alkyl), and wherein the carbon-based moiety can itself be further substituted. When a substituent is monovalent, such as, for example, F or Cl, it is bonded to the atom it is substituting by a single bond. When a substituent is divalent, such as O, it is bonded to the atom it is substituting by a double bond; for example, a carbon atom substituted with O forms a carbonyl group, C═O.

A “solvent” as described herein can include water or an organic solvent. Examples of organic solvents include hydrocarbons such as toluene, xylene, hexane, and heptane; chlorinated solvents such as methylene chloride, chloroform, and dichloroethane; ethers such as diethyl ether, tetrahydrofuran, and dibutyl ether; ketones such as acetone and 2-butanone; esters such as ethyl acetate and butyl acetate; nitriles such as acetonitrile; alcohols such as methanol, ethanol, and tert-butanol; and aprotic polar solvents such as N,N-dimethylformamide (DMF), N,N-dimethylacetamide (DMA), and dimethyl sulfoxide (DMSO). Solvents may be used alone or two or more of them may be mixed for use to provide a “solvent system”.

The term, “repeat unit”, “repeating unit”, or “block” as used herein refers to the moiety of a polymer that is repetitive. The repeat unit may comprise one or more repeat units, labeled as, for example, repeat unit A, repeat unit B, repeat unit C, etc. Repeat units A-C, for example, may be covalently bound together to form a combined repeat unit. Monomers or a combination of one or more different monomers can be combined to form a (combined) repeat unit of a polymer or copolymer. Copolymers disclosed herein can comprise random or block copolymers.

The term “molecular weight” for the copolymers disclosed herein refers to the average number molecular weight (Mₙ). The corresponding weight average molecular weight (M_{w}) can be determined from other disclosed parameters by methods (e.g., by calculation) known to the skilled artisan.

In various embodiments, the ends of the polymer (i.e., the initiator end or terminal end) can be a low molecular weight moiety (e.g. under 500 Da), such as, H, OH, OOH, CH₂OH, CN, NH₂, or a hydrocarbon such as an alkyl (for example, a butyl or 2-cyanoprop-2-yl moiety at the initiator and terminal end), alkene or alkyne, or a moiety as a result of an elimination reaction at the first and/or last repeat unit in the copolymer, or as specified otherwise.

A redox-active group or moiety can undergo oxidation and reduction. When in an oxidized state, the redox-active group is electron withdrawing and affects the electron density of a neighboring substituent such as the halo group of formula IA (e.g., when X is iodide).

### Embodiments of the Technology

1. A metallopolymer comprising formula IA or formula I:

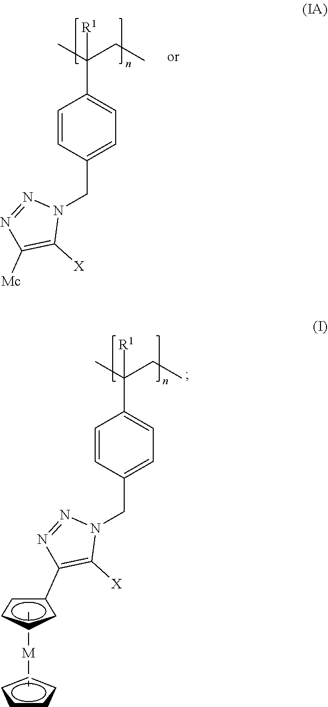

wherein,
Mc of formula IA is a redox-active group;
M of formula I is a transition metal or transition metal ion;
R¹ is H or —(C₁-C₆)alkyl;
X is halo (halide) or hydrogen (H); and
n is an integer from about 10 to about 100,000 (and, for example, a range between any two integers selected from the integers 10, 20, 25, 50, 75, 100, 150, 175, 200, 225, 250, 500, 1,000, 5,000, 10,000, 20,000, 25,000, 50,000, 75,000, and 100,000); and wherein the metallopolymer is redox-active.

In some embodiments of statement 1 above, Mc is, but is not limited to, a metallocene such as ferrocene or cobaltocenium, or a heterocycle such as a tetrathiafulvalene or viologen, e.g., phenyl viologen.

2. The metallopolymer of embodiment 1 wherein M is iron metal (Fe) or an iron metal ion, or a metal or ion of Ru, Os, Co, Rh, Ni, or Mn.

3. The metallopolymer of embodiment 1 or 2 wherein X is iodide or bromide (e.g., an iodo or bromo substituent).

4. The metallopolymer of any one of embodiments 1-3 wherein R¹ is H or methyl.

5. The metallopolymer of any one of embodiments 1-4 wherein the metallopolymer is P(FcTS-I):

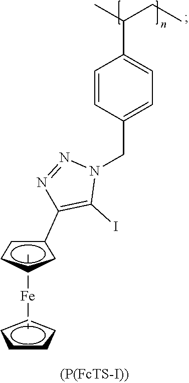

wherein n is an integer from about 10 to about 100,000.

6. The metallopolymer of any one of embodiments 1-5 wherein the metallopolymer is P(FcTS):

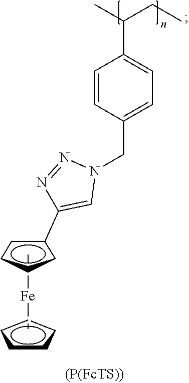

wherein n is an integer from about 10 to about 100,000.

7. The metallopolymer of any one of embodiments 1-6 wherein n is about 25 to about 250.

8. A redox electrode comprising a metallopolymer according to any one of embodiments 1-7, a carbon allotrope, and a crosslinker.

9. The redox electrode of embodiment 8 wherein the metallopolymer and the carbon allotrope have a mass ratio of about 0.25:1 to about 1:1, or a range anywhere between the ratios 0.25:1 and 1:1, such as about 0.3:1, 0.4:1, 0.5:1, 0.6:1, 0.7:1, 0.75:1, 0.8:1, 0.9:1, or 0.95:1.

10. The redox electrode of embodiment 8 or 9 wherein the carbon allotrope is a carbon nanotube.

11. The redox electrode of any one of embodiments 8-10 wherein the crosslinker is 1,3-benzenedisulfonyl azide.

12. The redox electrode of embodiment 11 wherein the crosslinker is inserted via a nitrene into C—H bonds of the metallopolymer and the metallopolymer is crosslinked.

13. The redox electrode of embodiment 11 or 12 wherein the crosslinker has a wt. % of about 5% to about 20% in relation to the metallopolymer.

14. An electrochemical method for sensing or separating anions, comprising:
a) contacting a solution comprising a suitable solvent (such as acetonitrile, ethanol, or water, and optionally comprises tetrabutylammonium hexafluorophosphate), a mixture of anions, and a redox electrode according to any one of embodiments 8-13;
b) applying a voltage potential to the redox electrode wherein the voltage potential is applied under suitable conditions for chronoamperometry or voltammetry;
c1) sensing a target anion in the mixture via a change in voltage, current, or impedance relative to a reference electrode; and/or
c2) separating from the mixture a target anion;

wherein the redox electrode selectively binds to a target anion in the mixture thereby sensing the target anion in the mixture, separating the target anion from the mixture, or both.

15. The method of embodiment 14 wherein the applied voltage potential is sufficient to oxidize or reduce the metallopolymer of the redox electrode.

16. The method of embodiment 14 or 15 wherein the target anion is a halide or an oxyanion, and optionally, wherein the method is selective for one or more halides over oxyanions.

17. The method of embodiment 16 wherein the target anion is Cl⁻, Br⁻, I⁻, HSO₄⁻, NO₃⁻, ClO₄⁻, PhSO₃⁻, or PhHPO₃⁻.

18. The method of any one of embodiments 14-17 wherein the redox electrode selectively binds to a target anion in the mixture (e.g., a halide over an oxyanion).

19. The method of any one of embodiments 14-18 wherein the metallopolymer of the redox electrode is poly(5-iodo-4-ferrocenyl-1-(4-vinylbenzyl)-1H-1,2,3-triazole) (P(FcTS-I)) or poly(4-ferrocenyl-1-(4-vinylbenzyl)-1H-1,2,3-triazol (P(FcTS)).

20. The method of embodiment 19 wherein the redox electrode selectively binds to a target anion via an electron depleted sigma hole in the halogen binding site of P(FcTS-I) when ferrocene (Fc) is oxidized to ferrocenium (Fc⁺) or via hydrogen bonding to P(FcTS) when Fc is oxidized to Fc⁺.

### Results and Discussion

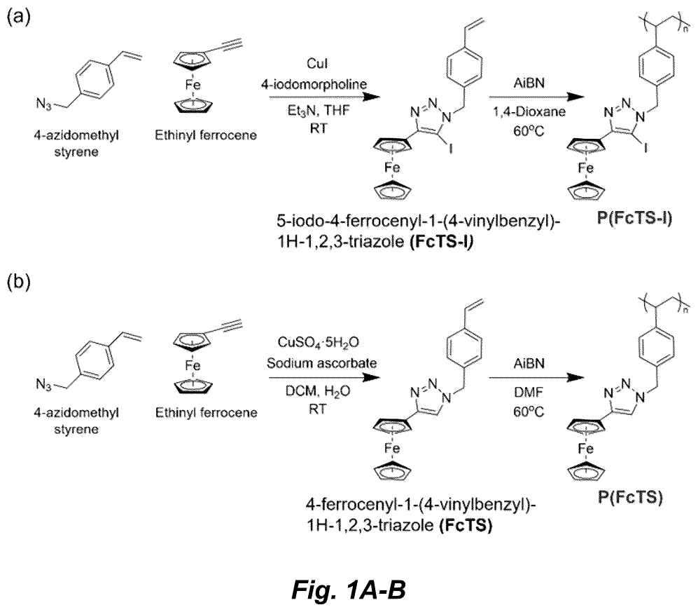

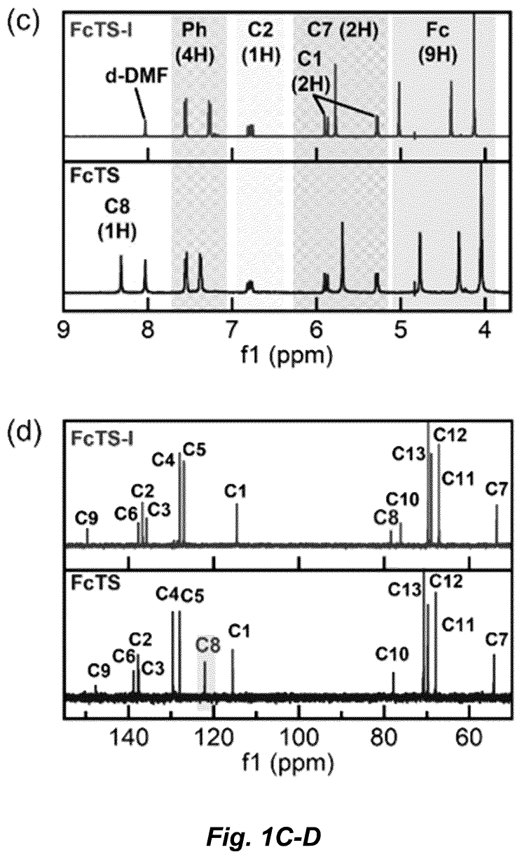

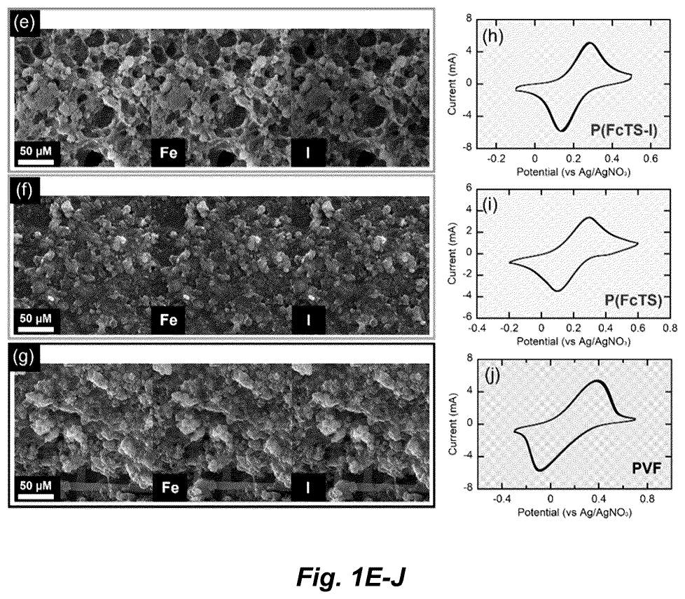

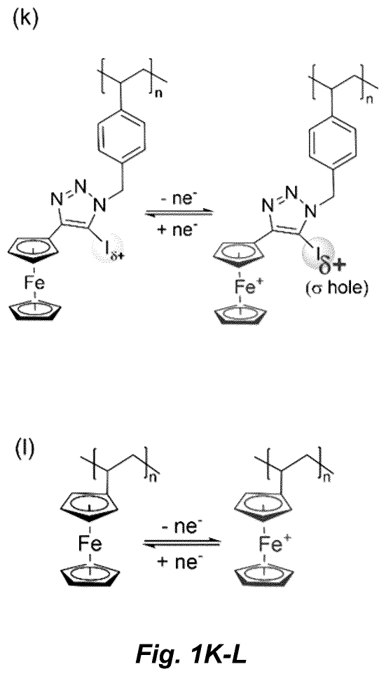

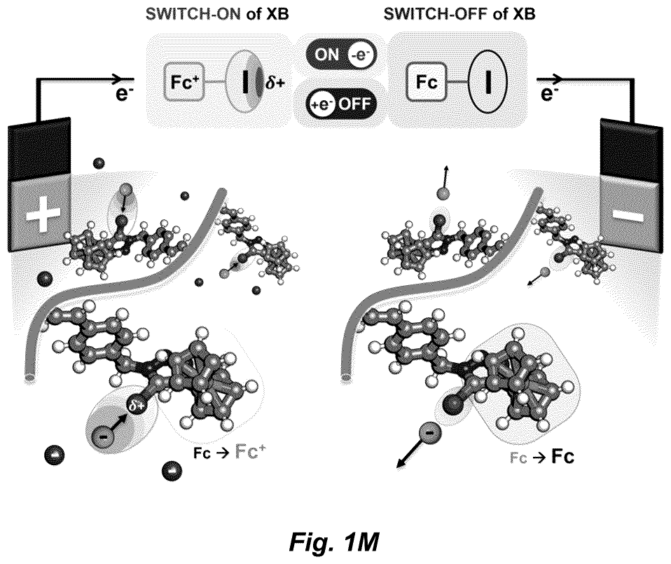

Here, we design and synthesize a new macromolecular platform for leveraging electrochemically responsive XB as a highly selective interaction for the separation of charged species in organic media (FIG. 1M). We designed a halogen bonding donor metallopolymer, poly(5-iodo-4-ferrocenyl-1-(4-vinylbenzyl)-1H-1,2,3-triazole) (P(FcTS-I)), to translate the electrochemically responsive supramolecular recognition onto a heterogeneous selective electrosorption. The oxidation of ferrocene in P(FcTS-I) amplifies the partial positive site (σ-hole) on the halide atom to form a non-covalent bond with anions. Conversely, the bound species are released upon the reduction of the ferrocene moiety.

Synthesis of P (FcTS-I) and its heterogeneous electrode design. A ferrocene-containing halogen bonding (XB) donor molecule, 5-iodo-4-ferrocenyl-1-(4-vinylbenzyl)-1H-1,2,3-triazole (FcTS-I) was prepared by Cu(I)-catalyzed azide-alkyne cycloaddition (CuAAC) (FIG. 1a). FcTS-I contains the redox-active ferrocene motif, which serves as a switchable electron-withdrawing group conjugated to 1,2,3-triazoles to facilitate the electron relocation between redox-active ferrocene and the halogen atom (iodine). Among halogen atoms, iodine can promote a strong electron-depleting region (σ-hole) on the elongation of the covalent bond (C—I) due to its high polarizability. In addition, our unique halogen bonding donor molecule features a polymerizable styrene moiety. The monomer was polymerized by free-radical polymerization, to prepare an organometallic polymer that can be immobilized onto a heterogeneous electrode. Hydrogen bonding (HB) donor monomer, 4-ferrocenyl-1-(4-vinylbenzyl)-1H-1,2,3-triazole (FcTS), and its polymer were also synthesized as control molecules using similar synthesis methods as FcTS-I (FIG. 1b).

Along with ¹H-NMR, ¹³C-NMR, and sets of 2-D NMR enabled identifying the structure of FcTS-I and FcTS molecules with corresponding hydrogen and carbon peaks. For FcTS, an extra singlet peak at 8.32 ppm depicted the HB donor site on C8 (FIG. 1c). Due to the presence of iodine, C8 for FcTS-I was more electron shielded by a heavy atom effect, resulting in the upfield shift from 122.00 (C8 peak for FcTS) to 79.13 ppm (FIG. 1d).

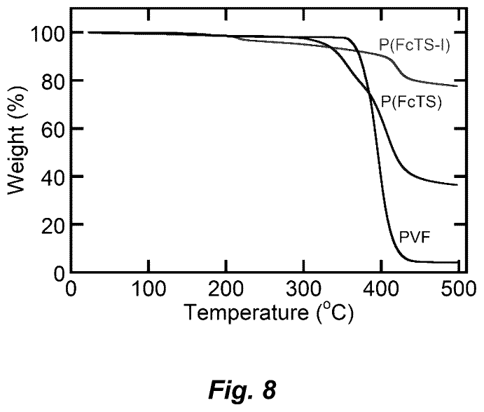

The three ferrocene-based metallopolymers (P(FcTS-I), P(FcTS), and polyvinyl ferrocene (PVF)) were incorporated onto electrodes according to literature protocols (Nature communications 2018, 9, 1 and Advanced Functional Materials 2016, 26, 3394). To prepare the electrode, carbon naubes (CNT) and redox-active polymers were dispersed at a mass ratio of 0.5:1, along with a 15 wt % cross-linker (1,3-benzenedisulfonyl azide). The dispersed mixture was then drop-casted onto the electrode substrate and dried at 140° C. to prevent leaching of the organometallic electrode. TGA analysis indicates remarkable thermal stability in all three metallopolymers, especially below 210° C. (FIG. 8). Thus, electrode fabrication at 140° C. with a cross-linker is expected to avoid any polymer degradation.

The scanning electron microscope (SEM) images of ferrocene-based organometallic electrodes (P(FcTS-I), P(FcTS), and PVF) showed uniform dispersion of composite on the carbon paper (FIGS. 1e-g). Energy-dispersive spectroscopy (EDS) mapping images showed a uniform distribution of iron onto the carbon paper. In particular, a one-to-one ratio between iron and iodine contents was observed for the EDS mapping image of P(FcTS-I), which agrees with the elemental analysis results and polymer characterizations.

Electrochemical characterization of the redox-polymers. The functionalized redox electrodes are utilized as heterogeneous platforms to study the electrochemically-reversible halogen bonding, hydrogen bonding, and direct binding onto the ferrocene redox centers. We demonstrated cyclic voltammograms (CV) of three metallopolymer electrodes to demonstrate the reversibility and stability of redox-active moiety over 20 cycles. In this experiment, we used activated carbon clothes as the counter electrode to avoid any potential impact from high counter potential or solvent degradation. CV of three metallopolymer electrodes reveals a single oxidation/reduction peak, confirming one electron transfer between ferrocene and ferrocenium (FIGS. 1h-j). However, E_{1/2} varied with different conjugates on the ferrocene, and the values were 0.25 V, 0.20 V, and 0.15 V for P(FcTS-I), P(FcTS), and PVF, respectively. The positive shift in the E_{1/2} value often reflects the electron-deficient nature of the ferrocene. In this regard, the electronegative iodine on the P(FcTS-I) thermodynamically disfavored oxidation of ferrocene moiety by depleting the electron on the ferrocene, resulting in the greatest anodic peak shift of E_{1/2} (FIG. 1d). The downfield shift of ferrocene peaks of FcTs-I on ¹H-NMR spectra by δ_{C11}0.25, δ_{C12}=0.09, and δ_{C2}=0.09 ppm in comparison to FcTS and by δ_{C11}=0.57, δ_{C12}=0.15, and δ_{C12}=0.01 ppm in comparison to vinyl ferrocene also supports the electron depletion on ferrocene and positive shift in the E_{1/2} value (FIG. 1c).

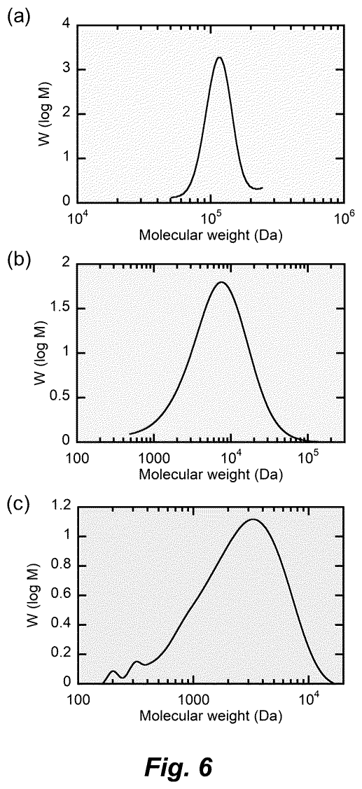

CV at varying scan rates from 100 mV/s to 10 mV/s showed distinct kinetic behaviors among three metallopolymers. Both P(FcTS-I) and P(FcTS) agree with the Randle-Sevcik equation with the R² value of >0.99, indicating reversible and diffusion-controlled electron transfer reactions. On the other hand, PVF displayed notable peak splitting between oxidation and reduction reactions, indicating a quasi-reversible system. We believe that the limitations in electron-transfer kinetics may stem from the wide range of molecular weight distribution in PVF, which contains remaining monomers and oligomers (FIG. 6). This could possibly lead to loosely crosslinked electrodes or uneven distribution of the metallopolymers on the CNTs. Unlike aqueous media, these metallopolymers tend to dissolve in organic media. Our study emphasizes the significance of material optimization, such as polymer and electrode synthesis, as well as the judicious design of the electrochemical system to enhance stability.

In the case of P(FcTS-I) and P(FcTS), we expected that the ferrocene moiety would serve as a cooperative binding site to support binding target species. As an electron-withdrawing group, ferrocene activated the halogen and hydrogen bondings when ferrocene oxidized to ferrocenium (Fc⁺) (FIG. 1k). In the case of P(FcTS-I), oxidized ferrocene redistributed the electron on the iodine, generating an electron-depleted region of σ-hole for halogen bonding. On the other hand, oxidized ferrocene in PVF served as a direct binding site (FIG. 1l), where the cyclopentadienyl group distributed electrons through the π-π interactions and formed a hydrogen bonding with the anion species.

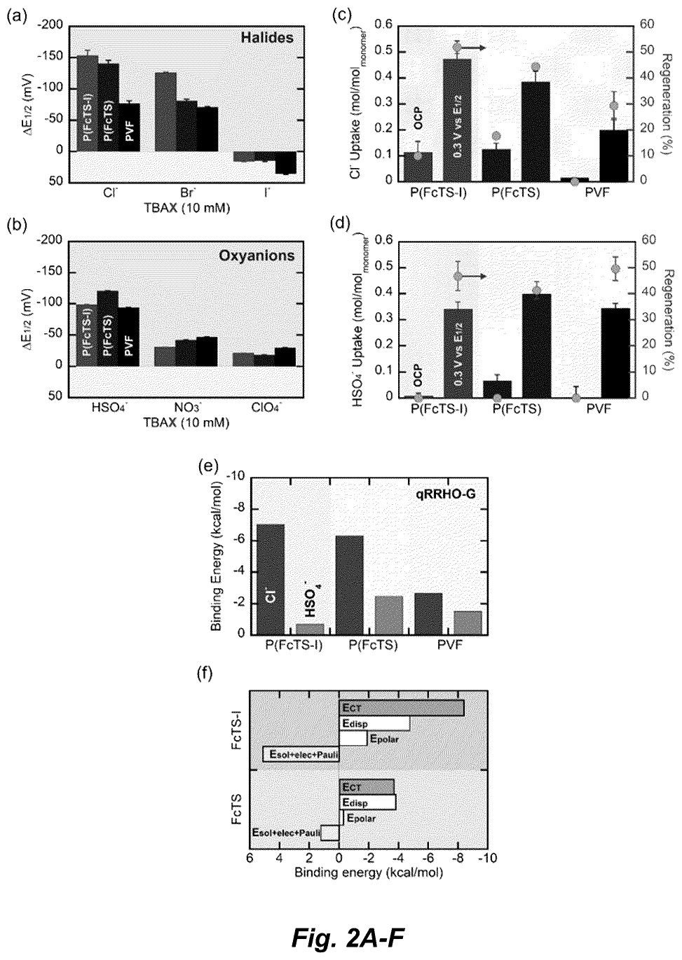

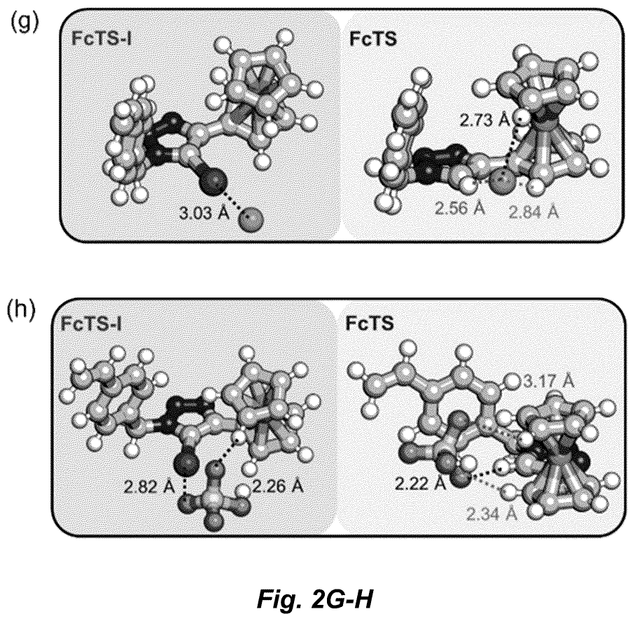

Selective inorganic anion recognition and electrosorption using redox-switchable halogen bonding. The electrochemical sensing response of P(FcTS-I) was evaluated to a series of inorganic anions (halides: Cl⁻, Br⁻, and I⁻ and oxyanions: HSO₄⁻, NO₃⁻, and ClO₄⁻), and compared with P(FcTS) and PVF (FIG. 2a, 2b and Table 1). For examining the anion recognition among these target anions, the peak shift in E_{1/2} (ΔE_{1/2}) was used as an electroanalytical measure to qualitatively inform on the binding affinities between metallopolymer and target anions. As shown in FIG. 2a, P(FcTS-I) revealed average of 32% and 88% greater ΔE_{1/2} for chloride (ΔE_{1/2}=−153 mV) and bromide (ΔE_{1/2}=−140 mV) than P(FcTS) and PVF, respectively. This result highlights the presence of strong XB intermolecular interactions between σ-hole on the P(FcTS-I) and target anions. Since the strength of XB is highly dependent on the electronegativity of the target anions, which, in turn, correlates with charge density and basicity, the trend of electrochemical sensing response follows the electronegativity of the halides (Cl⁻>Br⁻>I⁻) of all redox-active metallopolymers (FIG. 2a). Of oxyanions, bisulfate (HSO₄⁻) revealed the strongest sensing response of ΔE_{1/2}=−98 mV towards P(FcTS-I), followed by NO₃⁻ (−30 mV) and ClO₄⁻ (−21 mV) (FIG. 2b and Table 1). Oxyanions, which have relatively low charge density compared to halides, interacted with P(FcTS-I) through weak XB interactions. Thus, oxyanions interacted with P(FcTS) and PVF more favorably through hydrogen bonding.

TABLE 1
Summary of E_{1/2} (in V) and peak shift values (in mV) for
a series of inorganic anions, including halides (Cl⁻, Br⁻, and I⁻)
and oxyanions (HSO₄⁻, NO₃⁻, and ClO₄⁻) for the
three metallopolymers: P(FcTS-I), P(FcTS), and PVF.

| | E_{1/2} | Cl⁻ | Br⁻ | I⁻ | HSO₄⁻ | NO₃⁻ | ClO₄⁻ |
|---|---|---|---|---|---|---|---|
| P(FcTS-I) | 0.25 | −152.9 | −125.6 | 15.8 | −98.1 | −30.3 | −21.0 |
| P(FcTS) | 0.20 | −140.3 | −80.7 | 14.3 | −120.3 | −41.7 | −17.9 |
| PVF | 0.51 | −76.5 | −70.7 | 35.6 | −93.8 | −46.8 | −29.7 |

We then leveraged XB as a new supramolecular interaction for selective electrosorption of chloride and bisulfate in the presence of ten times excessive hexafluorophosphate (10 mM PF₆⁻). The uptake values were calculated by the molar ratio between the target species and ferrocene in a unit of mol of target species divided by mol of monomer unit. Among the three metallopolymers, the highest chloride uptake of 0.47 mol_{Cl-}/molₘₒₙₒₘₑᵣ was achieved with P(FcTS-I), which is indicative of strong halogen bonding in comparison to hydrogen bonding with P(FcTS) (0.39 mol_{Cl-}/molₘₒₙₒₘₑᵣ) or PVF (0.20 mol_{Cl-}/molmonomer) (FIG. 2c). Moreover, compared to the open-circuit potential (OCP), the utilization of P(FcTS-I) has increased by 4.2 times under the applied potential, emphasizing the amplification of σ-hole through the cooperative molecular design of the redox center (FIG. 1k).

With regards to the adsorption of oxyanions, P(FcTS-I) demonstrated a comparable uptake value of 0.34 mol/molₘₒₙₒₘₑᵣ for HSO₄⁻ and 0.39 mol/molₘₒₙₒₘₑᵣ for NO₃⁻ that of FcTS (0.40 and 0.36 mol/molₘₒₙₒₘₑᵣ) and PVF (0.34 and 0.39 mol/molₘₒₙₒₘₑᵣ) (FIG. 2d). We observed exclusive uptake of target species for all ferrocene-based organometallic polymers, despite the presence of excess PF₆⁻ in the solution. The negative charge of PF6⁻ is evenly distributed among its six fluorine atoms, exhibiting low electron density for each fluorine atom. Consequently, the weak atomic partial charges of fluoride lead to low binding affinity towards the metallopolymer, resulting in highly selective uptake of target species with (halides and oxyanions) over PF6⁻.

To study the switch-off capability of XB, we demonstrated the desorption test for chloride and bisulfate at a reversal potential of −0.3 V vs E_{1/2}. P(FcTS-I) released 57% and 52% of the bound chloride and bisulfate, resulting in a 5.7-fold increase in regeneration compared to the OCP. Additionally, P(FcTS-I) exhibited a 34% higher regeneration performance on average than both FcTS and PVF. At an even higher negative potential of −0.8 V vs E_{1/2}, the weak σ-hole between P(FcTS-I) and chloride was completely deactivated, resulting in the release of 100% of the bound chloride. On top of the desorption capability, we performed long-term charging/discharging tests to demonstrate the stability and redox switchability of P(FcTS-I) over 200 cycles. Charging and discharging capacity was maintained at 88% and 87% respectively over 200 cycles with an overall coulombic efficiency above 99%, emphasizing the high electrochemical stability and reversibility P(FcTS-I). Overall, the adsorption and desorption tests, along with the long-term cycle operation demonstrate the switchable nature of halogen bonding by controlling the strength of the redox-active electron-withdrawing group, ferrocene.

Mechanistic understanding of selective electrosorption through density functional theory calculations. We conducted DFT calculations to understand the binding mechanism for selective electrosorption and deconvolute the potential role of halogen bonding from the redox-active motif. The ΔG trend aligned with the sensing and uptake results-showing [P(FcTS-I)]⁺—Cl⁻ the highest ΔG value of −7.04 kcal/mol compared to [P(FcTS)]⁺—Cl⁻ (ΔG=−6.31 kcal/mol) and PVF⁺—Cl⁻ (ΔG=−2.65 kcal/mol) (FIG. 2e). In particular, the binding energy for chloride on [P(FcTS-I)]⁺ was significantly stronger than bisulfate (ΔG=−0.68 kcal/mol), which confirms the preferential sorption of chloride through XB interactions. The robust binding between XB donor species and chloride is a result of the directional nature of the binding interactions (FIG. 2g) and the orbital overlap configuration between the two. The binding between P[FcTS-I]⁺ and Cl⁻ has a linear orientation with a bond length of 3.03 Å and a [C—I]—Cl⁻ angle of 178.5° (FIG. 2g). However, the binding between P[FcTS-I]⁺ and HSO₄⁻ involves both XB with a bond length of 2.82 Å and hydrogen bonding with a bond length of 2.26 Å on the cyclopentadienyl ring (FIG. 2h). By calculating the electron density (ρ) at the bond critical point, we confirmed that the excess electron in the Pz orbital of chloride allows for direct interaction with the sigma-hole of iodine on the elongation of the C—I bond. On the other hand, the excess electron in bisulfate is located in the highest occupied molecular orbital that resembles the p-orbitals of oxygen atoms with reduced charge density towards the sigma-hole of iodine, leading to weaker interaction. Both the molecular level binding mechanism and experimental observations indicate that several factors influence the binding affinity, including not only the electronegativity of the species but also the molecular structure, charge density and distribution, basicity, competing ions, and solvent.

The nature of the interaction between Cl⁻ and HSO₄⁻ and oxidized FcTS-I and FcTS molecules was further probed through energy decomposition analysis (FIG. 2f). The result shows that the charge transfer interaction serves as the primary contributor in stabilizing the [P(FcTS-I)]⁺—Cl⁻ system, with an energy of −8.41 kcal/mol. This strong interaction is evidence of XB binding between oxidized FcTS-I and Cl⁻ through the charge transfer interaction between the filled orbital of chloride and the unoccupied orbital localized on iodine, as evidenced by the complementary occupied and virtual pair orbitals (COVP) analysis. Both occupied chloride orbital and unoccupied iodine orbitals are directed towards each other and aligned along the same axis, resulting in a directional halogen bonding. This strong interaction and stability of the complex molecule are further enhanced through the synergistic effects of dispersion and polarization with the charge transfer, while the combination of solvation, electrostatic, and Pauli repulsion energies (E_{sol+Elec+Pauli}) exerts a counteractive effect on the binding of chloride to the oxidized P(FcTS-I), largely due to the high positive solvation energy.

In the absence of directional XB, weak binding interactions were observed within the complex molecule. The COVP orbitals in the [P(FcTS)]⁺—Cl⁻ system revealed that occupied orbitals localized on chloride and virtual pairs were distributed over C—H bonds of triazole and cyclopentadienyl ring, resulting in relatively weak charge transfer and dispersion interactions between [P(FcTS)]⁺—Cl⁻ compared to [P(FcTS-I)]⁺—Cl⁻ (FIG. 2f). The energy decomposition analysis for bisulfate binding also showed that dispersion is the dominant interaction of both [P(FcTS-I)]⁺ and [P(FcTS)]⁺, followed by charge transfer, which agrees with the bond critical points analysis. In particular, the prevalent dispersion interactions arising from multiple hydrogen bondings between bisulfate and hydrogen atoms on the cyclopentadienyl ring weakened the selective XB interactions of P(FcTS-I) and led to a similar binding mechanism and uptake as that of P(FcTS). The DFT calculations conclude that the directional charge transfer is the key factor responsible for the high selectivity and uptake for the P(FcTS-I) complex.

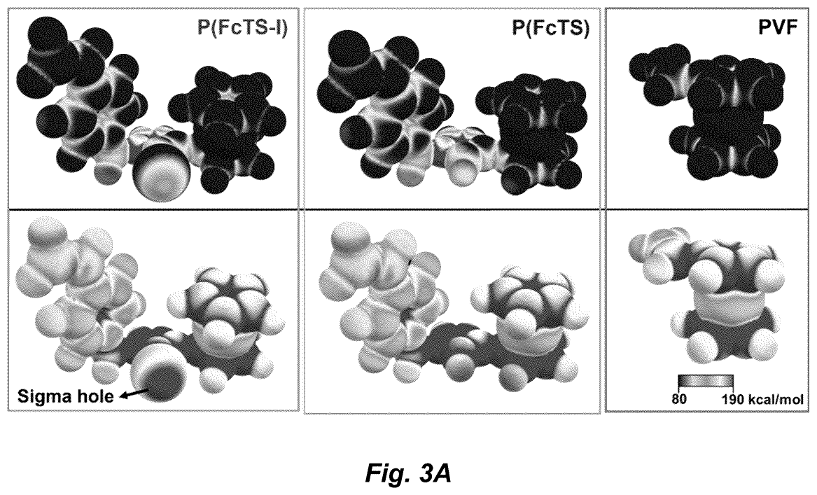

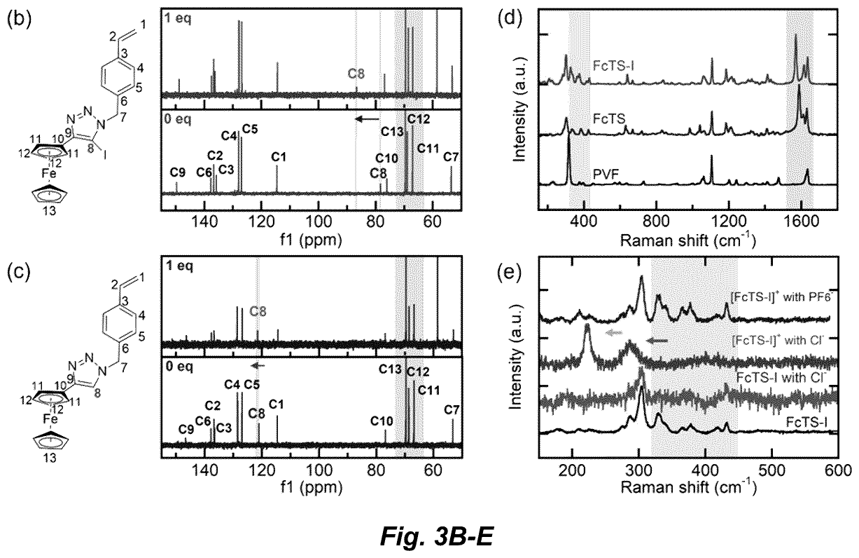

Spectroscopic and computational investigations to support the existence of halogen bonding interactions. The existence of XB interaction can be confirmed experimentally through the NMR and Raman studies in addition to the molecular electrostatic potential surface (EPS) mapping. EPS mapping of FcTS-I illustrates the remarkable delocalization of the excess positive charge, especially on the iodine, compared to the hydrogen(s) on the triazole motif in FcTS and cyclopentadienyl ring in the PVF (FIG. 3a). The strong positive potential (105 kcal/mol) on iodine at the rear end of the C—I bond indicates the presence of the σ-hole in the oxidized state of FcTS-I, while a slightly weak positive potential (39.1 kcal/mol) is still present in the neutral state. However, FcTS and vinyl ferrocene molecules involve lower positive potentials distributed among hydrogens in the triazole and cyclopentadienyl group than σ-hole, resulting in a weaker interaction between target species and hydrogen atoms than halogen bonding.

The strength of XB interaction can be measured by NMR titration in a neutral ferrocene state. A notable downfield shift (δ=8.32 and 9.23 ppm) of iodine-bound carbon (C8 for FcTS-I) was witnessed in the presence of 1 and 2 equivalents of Cl⁻, respectively (FIG. 3b). This distinct peak shift of C8 in FcTS-I indicates the presence of halogen bonding (I—Cl⁻) which weakens the heavy atom effect. For FcTS-I, C8 was originally upfield-shifted (FIG. 1c) as the iodine atom shared its electron with the adjacent light atom (C8) by the spin-orbital coupling, known as the heavy atom effect. When this heavy atom forms a halogen bonding with the Lewis base (Cl⁻), the electron shielding effect on the light atom becomes weak, resulting in a downfield shift in ¹³C-NMR. On the other hand, the presence of 1 and 2 equivalents of PF₆⁻ did not result in any significant peak shift due to its weak binding affinity towards σ-hole. This result aligns with the electrosorption and anion recognition results, which indicate a preferential molecular interaction with halides and oxyanions. Moreover, an insignificant shift (δ=0.45 ppm) in the C8 peak of FcTS upon the addition of 1 and 2 equivalents of Cl⁻ (FIG. 3d) highlights the presence of a sigma hole on the iodide of FcTS-I, serving as a binding site for Cr. Additionally, among the three studied organometallic species, no significant peak shift was observed in the ¹C-NMR and ¹-NMR spectra corresponding to the cyclopentadienyl rings, which suggests that there is a lack of hydrogen bonding between ferrocene and chloride when ferrocene is in a reduced state.

To assess the halogen bonding ability of oxidized FcTS-I, ex-situ Raman spectroscopy was performed since the unstable paramagnetic nature of iron makes it difficult to examine the peak shift of ferrocene-containing molecules through NMR. Prior to analyzing structure changes in FcTS-I, we verified two distinct regions in its Raman spectra, (150-450 cm⁻¹ and 1530-1680 cm⁻¹) compared to FcTS and PVF (FIG. 3d). Then DFT calculations confirmed that the observed peak regions, specifically below 400 cm⁻¹ in the Raman spectrum, correspond to C—I motions, including strong C—I bending and stretching at 223 cm⁻¹, 269 cm⁻¹, 299 cm⁻¹, and 419 cm⁻¹. During the oxidation of FcTS-I, the halogen bonding was accompanied by the downfield shift at low Raman shift regions with very broad signals, presumably originating from the increased bond length of C—I after the formation of the I—Cl⁻ bond (FIG. 3e). The Raman peak shift was not noticeable when FcTS-I was in its neutral state with chloride due to the weak interaction between the σ-hole and anion. Additionally, even upon oxidation of FcTS-I, PF₆⁻ did not cause any observable shift in the Raman peaks. This observation confirms halogen bonding serving as the primary binding site in the selective interaction between P(FcTS-I) and chloride, with the ferrocene motif acting as a secondary, synergistic binding site in the electrochemically responsive binding.

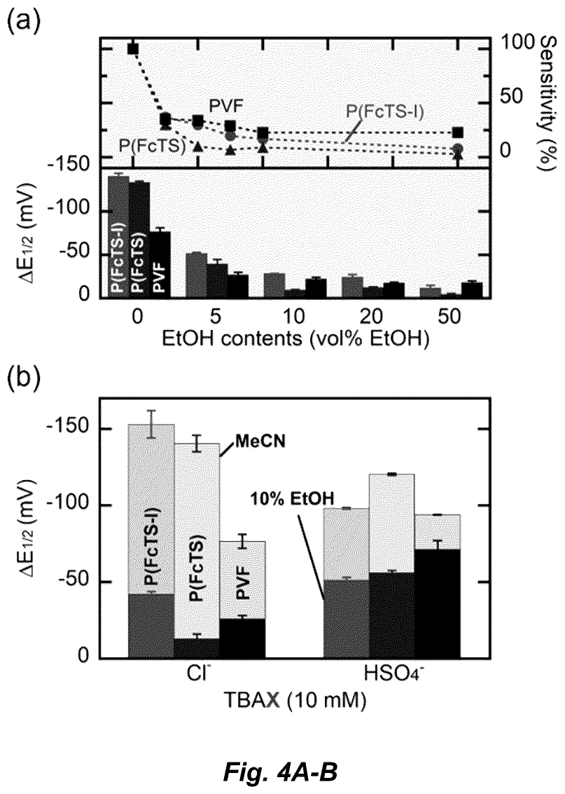

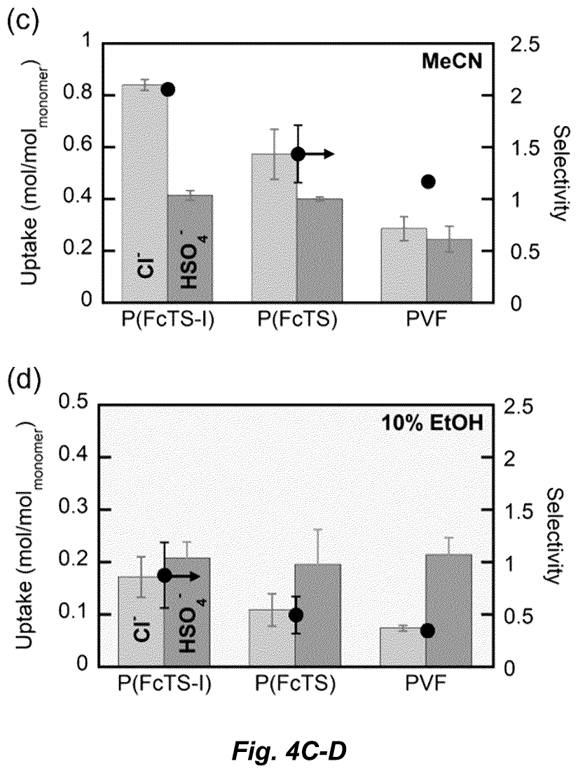

Effect of the protic solvent on sensing capabilities and selectivity of halogen bonding. The exceptional anion recognition properties of halogen bonding and its electrosorption can be observed even in a mixed volume percentage of water and ethanol (FIG. 4). Halogen bonding outperformed the anion recognition with peak shift values of −24 mV and −20 mV, for mixtures containing less than 20-vol % ethanol and 10-vol % water, respectively (FIG. 4a). On the other hand, the sensing capabilities of P(FcTS) were minimal in the mixtures containing 10 vol% ethanol and water. In a protic mixture, the solvent can serve as an alternative medium for stabilizing the redox-active unit, decreasing the sensing abilities of both halogen and hydrogen bonding due to the solvation effect and solvent interaction. In this context, P(FcTS) and PVF favor stabilizing ferrocenium by forming hydrogen bonds with the protic solvent mixture, while P(FcTS-I) still prefers binding chloride through halogen bonding to stabilize the ferrocenium.

Moreover, the solvation of anions largely influenced the binding affinity, leading to changes in selectivity patterns for anion recognition and electrosorption. In the 10-vol % ethanol mixture, anion recognition showed a reversal trend, with a 70-90% decrease in peak shift for chloride, but only 24-54% for bisulfate (FIG. 4b). The addition of ethanol also altered the uptake preference from chloride to bisulfate (FIG. 4c, 4d). In pure acetonitrile, P(FcTS-I) showed the highest selectivity towards chloride with a selectivity of 2.1, surpassing the selectivity values for P(FcTS) (1.4) and PVF (1.8). However, in the 10-vol % ethanol mixture, the three metallopolymers showed a higher affinity towards bisulfate, leading to a selectivity range of 0.35-0.87. The change in selectivity patterns can be attributed to distinct solvation behaviors of chloride and bisulfate. Chloride exhibits a higher degree of hydration, with six water molecules in a protic solvent, compared to bisulfate which can be stabilized with 1-4 water molecules. Thus, chloride stabilizes with the interaction of protic solvent, resulting in weaker interaction between chloride and the oxidized organometallic species than bisulfate. The reversal selectivity trend across P(FcTS-I), P(FcTS), and PVF, regardless of bonding types, implies that this trend is driven by the solvation of target species rather than changes in organometallic properties in the presence of a protic solvent. Overall, electrosorption results highlight that the selectivity can be controlled by the design of molecularly selective electroactive materials, as well as by modulating the solvent mixture.

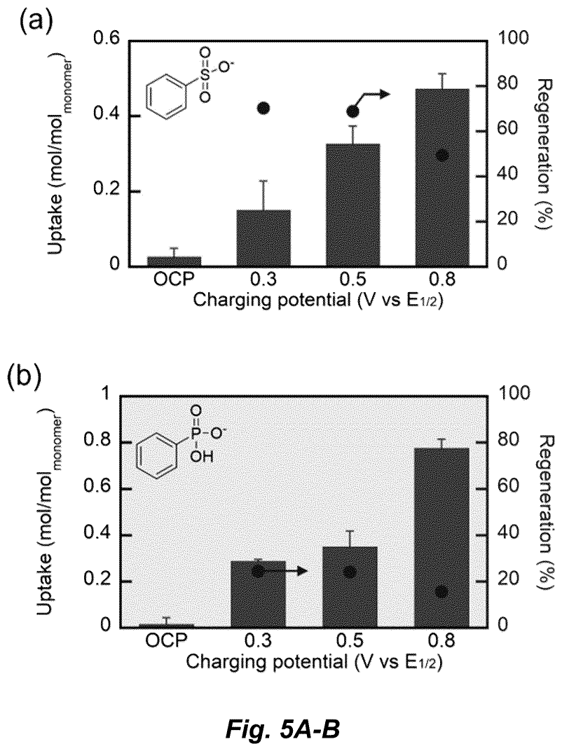

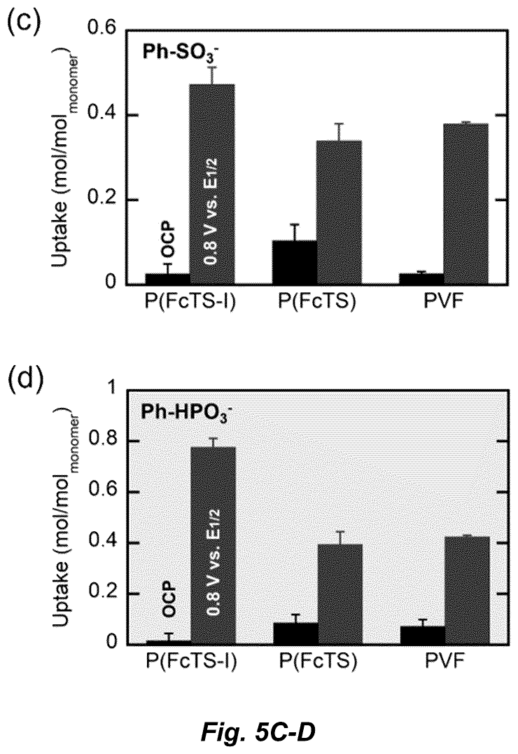

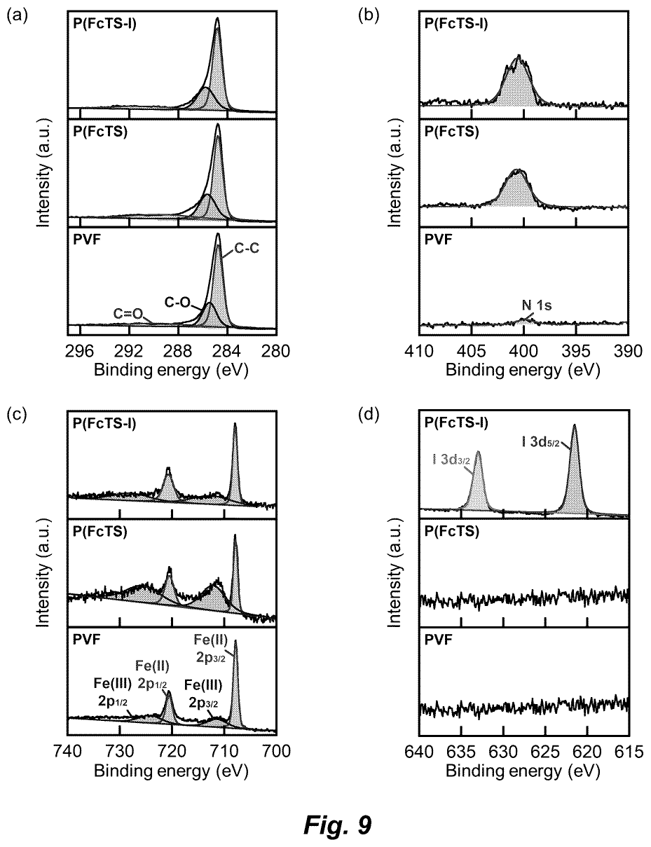

Redox-switchable halogen bonding for the recovery of organic molecules. The effectiveness of halogen bonding for the selective separation of target halides and oxyanions can be extended to organic molecules, such as benzene sulfonate (Ph-SO₃⁻) and phenyl phosphonate (Ph-HPO₃⁻), as model organic species used in the production of chemicals and pharmaceutical drugs (FIG. 5). A weak halogen bonding interaction was present at the open-circuit potential (OCP), resulting in insignificant uptake values of 0.026 and 0.016 mol/molₘₒₙₒₘₑᵣ for Ph-SO₃⁻ and Ph-HPO₃⁻, respectively (FIG. 5a, 5b). Out of the three metallopolymers studied, P(FcTS) displayed the highest uptake for both Ph-SO₃⁻ and Ph-HPO₃⁻ at the OCP with uptake values were 0.105 and 0.086 mol/molₘₒₙₒₘₑᵣ, respectively. This can be attributed to the inherent partial oxidation of P(FcTS) as shown in the OCP profiles and XPS spectra of the Fe2p (FIG. 9). As the applied potential increased from OCP to 0.8 V vs E_{1/2}, both uptake values of Ph-SO₃⁻ and Ph-HPO₃⁻ for P(FcTS-I) were 18 and 49 times enhanced, emphasizing the electrochemically responsive binding of P(FcTS-I) with charged organic species. Up to 70% of Ph-SO₃⁻ was released with a reversal potential, whereas only up to 25% of Ph-HPO₃⁻ was released due to its strong binding with P(FcTS-I), as confirmed by LSV results.

Furthermore, we compared the uptake performance of P(FcTS-I) with P(FcTS), and PVF as illustrated in FIGS. 5c and 5d. P(FcTS-I) exhibited 39% and 24% greater uptake of Ph-SO₃⁻ (0.43 mol/molₘₒₙₒₘₑᵣ) than P(FcTS) (0.31 mol/molₘₒₙₒₘₑᵣ) and PVF (0.34 mol/molₘₒₙₒₘₑᵣ). In addition, we obtained two-fold enhanced uptake of Ph-HPO₃⁻ with our halogen bonding donor molecule (0.71 mol/molₘₒₙₒₘₑᵣ) compared to P(FcTS) and PVF (0.36 and 0.39 mol/molₘₒₙₒₘₑᵣ, respectively). This result expands the capability of halogen bonding for separating diverse charged molecules in organic media, expanding the application scope of pharmaceuticals and chemical synthesis processes. In this regard, electrochemically responsive halogen bonding offers a paradigm shift in separation technology, allowing for tunable bonding strength through the selection of electron-withdrawing group, halides, solvent mixture, and operating conditions.

Conclusion. We demonstrated highly selective non-aqueous electrosorption in a heterogeneous redox-materials platform by designing a redox-active halogen bonding (XB) polymer, P(FcTS-I). Upon electrochemical oxidation of ferrocene, a strong partial positive charge (a-hole) was amplified, leading to highly selective and remarkable electrosorption of various halides, oxyanions, and charged organic molecules. This resulted in a 4.2-fold and up to 49-fold increase in the electrosorption for chloride and phenyl phosphonate, respectively compared to the open-circuit potential. In addition, the halogen bonding is selective towards halides, exhibiting 1.2-fold and 2.4-fold enhanced chloride uptake compared to P(FcTS) and PVF, due to its directional binding and affinity towards more electronegative ions. XB can be switched off by applying a negative potential, leading to a complete release of absorbed chloride. NMR titration and Raman spectroscopy elucidated that XB serves as a primary interaction, with the ferrocene serving as a switch for controlling the strength of XB, while DFT calculations provided evidence of amplification of a-hole upon the oxidation of ferrocene and the importance of directional bindings for the strong charge transfer interactions between a-hole and target species. Based on the remarkable uptake of model organic species, we can envision the capability of XB for ion-selective separations of a wide range of charge species beyond small ions. Overall, our work demonstrated selectivity, for the first time, the electrochemically-responsive XB donor polymer for selective electrosorption, holding great promise as a platform for electrochemical separation in organic media.

The following Examples are intended to illustrate the above invention and should not be construed as to narrow its scope. One skilled in the art will readily recognize that the Examples suggest many other ways in which the invention could be practiced. It should be understood that numerous variations and modifications may be made while remaining within the scope of the invention.

### EXAMPLES

### Example 1. Materials and Experimental Methods

Materials. All chemicals were obtained from Sigma Aldrich, TCI, VWR, AbaChemScene, and Fisher Scientific, and used as received. Poly(vinyl ferrocene) was purchased from Polysciences, while FcTS-I, FcTS, and their polymers were prepared as described below. The synthesis of 4-iodomorpholine-hydrogen iodide was described from Angewandte Chemie International Edition 2010, 49, 31.

Instrumentation. Gel permeation chromatography (GPC) was conducted to measure the relative molecular weight of polymers such as P(FcTS-I) and P(FcTS) (EcoSEC® HLC-8320, Tosohbioscience). Two Alpha-M columns were placed in series and 10-15 mg of samples were dissolved in DMF solution with 14.5 mM LiBr as supporting salt. As a standard poly(methyl methacrylate) was used. Flash chromatography was performed during the synthesis of our FcTS-I monomer using a Büchi Pure C-810 chromatography system with Büchi Pureflex Ecoflex silica cartridges as stationary phase. To obtain absolute molecular weight of PVF, we performed GPC with a PSS SECcurity2 system composed of a 1260 IsoPump G7110B (Agilent Technologies, Santa Clara, CA, USA), a 1260 VW-detector G7162A at 270 nm (Agilent Technologies) and a 1260 RI-detector G7114A at 30° C. (Agilent Technologies). We used THF as a mobile phase (flow rate 1 mL min⁻¹) on a SDV column set (SDV 103, SDV 105, SDV 106) from PSS (Polymer Standard Service, Mainz, Germany). Calibration was carried out using PS standards (from PSS). For data acquisition and evaluation of the measurements, PSS WinGPC® UniChrom 8.2 was used.

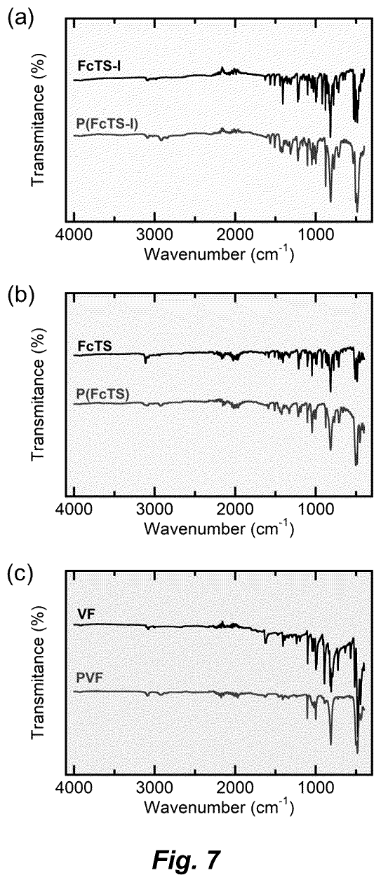

CHN analyzer (CE440, Exeter Analytical) enabled measuring the composition of carbon, hydrogen, and nitrogen in the compound. Samples were burned at a high temperature (1,800° C.) with He purge. Then the products mixed with reagents were analyzed by a series of thermal conductivity detectors for precision measurement of C, H, and N elements in organic compounds. Halide (iodide) was also measured by a halide probe (Orion Ion Selective Electrodes, Thermo Scientific) after the solid powders were combusted via the Schoniger oxidation method. Low and high-resolution electrospray mass spectrometry (ESI-MS) was performed to obtain the molecular weight of FcTS-I and FcTS using Synap G2, Q-Tof with 50/50 water/acetonitrile as a mobile phase. To investigate the functional groups of both monomers and polymers, attenuated total reflectance Fourier transforms infrared spectroscopy (ATR-FTIR, Thermo Nicolet iS50 FTIR) was monitored at room temperature. We typically measured the spectra between 400-4,000 cm⁻¹ (see FIG. 7).

¹H-NMR, ¹³C-NMR, and 2-D NMR (COSY, HSQC, and HMBC) were conducted to assign peak identities for our new compound FcTS-I and FcTS. We performed all NMR analyses at 500 MHz in 600 μL of deuterated-DMF (C₃D₇NO) with 15-30 mg of sample loading.

The thermal stability of three metallopolymers was tested by Q50 thermogravimetric Analysis (TGA). We measured the thermal decomposition of our polymers from room temperature to 500° C. with a temperature ramping rate of 5 K/min with a balance sensitivity of 0.1 μg.

Electrode synthesis and characterization. The electrode was synthesized via the drop-casting method (Advanced Functional Materials 2021, 31, 2009307). A redox-active polymer such as P(FcTS-I), P(FcTS), and PVF was dispersed with carbon nanotubes (CNTs) as a conducting additive with 1:0.5 mass ratios (8 mg:4 mg) in 2 mL chloroform. The addition of CNTs does not contribute to electrosorption, as indicated by the negligible capacitance observed in the cyclic voltammetry (CV) plot of the CNT-control electrode. As our experiment is conducted in an organic solvent, there is a possibility of metallopolymer electrodes leaching into the solution in the absence of a crosslinker, as demonstrated by the control CV experiment. To prevent this, we added 1,3-Benzenedisulfonyl azide (15 wt % of metallopolymer) as a crosslinker to the mixture solution, prepared according to literature (Journal of applied polymer science 2001, 79, 1092). The introduction of a crosslinker, disulfonyl azide, allows the formation of crosslinks within the polymer film, preventing any dissolution of the polymer. When the temperature is increased to above 120° C., reactive nitrene species from disulfonyl azide are formed, which insert into the C—H bonds of the polymer (Macromolecules 2016, 49, 5076). 50 μL of the electrode solution was drop-casted twice on the carbon paper electrode (1 cm×1 cm). The coated electrode was dried in the oven at 140° C. for 2 hours. According to the TGA analysis, all three metallopolymers exhibit excellent thermal stability, especially at temperatures lower than 210° C. (FIG. 8). Therefore, utilizing a cross-linker to synthesize the electrodes at 140° C. is unlikely to result in any degradation of the polymer. With the active surface of 1 cm×1 cm, 100 μL drop-casting led to the final loading of 0.6 mg of redox-active material.

To observe electrode surface morphology, both scanning electron microscopy (SEM, Axia ChemiSEM, Thermo Fisher) and energy-dispersive X-ray spectroscopy (EDS) were performed under high vacuum Everhart-Thornley SE detector (ETD) mode with an accelerating voltage of 30 kV and a spot size of 4.0. Furthermore, the surface chemical compositions of heterogeneous electrodes (metallopolymer with CNT) were analyzed by X-ray photoelectron spectroscopy (XPS, MSE Supplies LLC) to evaluate the binding energies of C, N, O, Fe, and I (FIG. 9). The XPS analysis revealed distinctive peaks of I 3d_{3/2} and I3d_{5/2}, corresponding to the iodide present in the P(FcTS-I) electrode. Additionally, there was a prominent N 1s peak indicating the presence of nitrogen atoms in the triazole group of both P(FcTS-I) and P(FcTS) electrodes.

Electrochemical studies. Molecular recognition studies were conducted via cyclic voltammogram. The sensing capability of the redox-active polymer was measured by the peak shift of CV (ΔE_{1/2}) in the absence and presence of the 10 mM of target species. All the sensing experiments were conducted in 5 mL of solution with 100 mM of TBAPF₆ as an electrolyte and the three-electrode system with Ag/AgNO₃ as a reference electrode. CV was run in 100 mM of TBAPF₆ for 10 cycles under nitrogen to obtain the stable E_{1/2} without the target species. Then the solution was switched to 10 mM target anions along with the 100 mM TBAPF₆ to run CV in the presence of the target species. E_{1/2} was calculated with the 3^{rd} cycle and the difference in half-cell potential was compared among various target anions, including halides (Cl⁻, Br⁻, I⁻) and oxyanions (HSO₄⁻, ClO₄⁻, NO₃⁻). The Biologic software was used to calculate the peak current and corresponding potentials in order to determine E_{1/2} and ΔE_{1/2}. However, due to the broad peak shape observed when strong binding target species (e.g., Cl⁻) were introduced, there was a chance of encountering errors. To address the potential errors resulting from peak selection, we conducted the anion recognition experiments twice with fresh solutions and newly synthesized electrodes. The error bars for ΔE_{1/2} demonstrated that the error caused by broad peaks was minimal, with an average standard deviation of ±1.7 mV. This minimal error did not significantly affect the trend in binding strength among the various anions.

The electrosorption test was conducted in chronoamperometry mode for 15 minutes in the three-electrode system with Ag/AgNO₃ as a reference electrode. With linear sweep voltammetry, we selected an adsorption potential of 0.3 V with respect to E_{1/2} for both chloride and bisulfate to avoid side reactions and provide equivalent redox reactions among three metallopolymers. For the electrosorption test, we adjusted the ionic strength for the electrosorption to enhance the accuracy of the measurements. To verify the concentration difference (ΔC=approximately 0.1 mM) before and after the electrosorption tests, we used 10 times lower ion concentrations (1 mM TBAl in 10 mM TBAPF₆) than those used in the anion recognition tests (10 mM TBACl in 100 mM TBAPF₆). Unless specified otherwise, the adsorption test consisted of 5 mL of a solution containing 1 mM target species and 10 mM TBAPF₆, while the desorption test used 20 mM TBABF₄ under nitrogen.

We conducted three identical adsorption experiments with fresh solutions and newly synthesized electrodes to demonstrate the reproducibility of our results. The concentrations of target species were measured by ion chromatography (IC, Dionex Integration, Thermofisher Scientific) for small anions such as Cl⁻, PF₆⁻ and high-performance liquid chromatography (HPLC, Agilent 1260 Infinity II, Agilent) for charged organic species such as benzene sulfonate and phenyl phosphonate. Since our experiments were conducted in organic solvents with hexafluorophosphate (PF₆⁻) or tetrafluoroborate (BF₄⁻) with IonPac AS-22 column, the mixture of DI and acetonitrile was used as an eluent solvent. Fresh eluent was prepared with 4.5 mM NaHCO3 and 1.4 mM Na₂CO₃ of a mixture of DI and acetonitrile with 70 vol %:30 vol % and preserved under nitrogen. The samples were run at the flow rate of 0.9 mL/min for 18 min to detect Cl⁻, HSO₄⁻, and PF₆⁻. The organic acid concentration was measured by HPLC with the C₁₈ column (4.6 mm×100 mm×2.7 μm, Agilent Poroshell 120) at the flow rate of 0.5 mL/min. 5% of phase A (Acetonitrile) and 95% of phase B (0.1% trifluoroacetic acid (TFA) in DI) was used with the sample injection volume of 5 μL for 8 min.

Mechanistic understandings through spectroscopy. NMR titration was conducted to understand the molecular interaction in a neutral state. The redox-active monomers (240 mM) were dissolved in 500 μL of deuterated-DMF. Both ¹H-NMR and ¹³C-NMR were measured as 1 M TBAl was added to the monomers up to 5 equivalents. Then the peak shifts of ¹H-NMR and ¹³C-NMR were analyzed to provide insights into the binding sites in the neutral state of ferrocene. As a control experiment, NMR titration was also conducted with 1 M TBAPF₆ and compared with the peak shift of P(FcTS-I) with C⁻.

Ex-situ Raman spectroscopy was performed to understand the molecular interaction. Since ferrocenium is paramagnetic, we cannot measure the peak shift with NMR. To obtain samples for Raman, homogeneous experiments were conducted with 5 mM of redox-active monomers dissolved in 5 mL of acetonitrile. We obtained the first sample (pristine, 1 mL) after 30 min of stirring. Then 1 equivalent of the target species (250 mM, 80 μL) was added to the solution, and the second sample (1 mL) was collected after 30 min of stirring (interaction between the reduced redox-active monomer with target species). With a three-electrode system (platinum as working and counter electrodes and Ag/AgNO₃) as a reference electrode, the redox-active monomer was oxidized for 30 min at 0.5 V Ag/AgNO₃ and the last sample (1 mL) was collected. Samples at three different experimental conditions were fully dried under vacuum conditions prior to Raman spectroscopy. Then the dried powder was loaded on the microscope slides to measure the Raman spectroscopy. Raman spectra were then obtained by Nanophoton Raman 11 spectrometer using an excitation wavelength of 532 nm with a grating of 600 gr/mm. We used an excitation power of 1.5 mW and an exposure time of 15 seconds, repeating the measurements five times on the same spot with a readout speed of 2 MHz.

### Example 2. Preparation of Metallopolymers and Material Characterizations

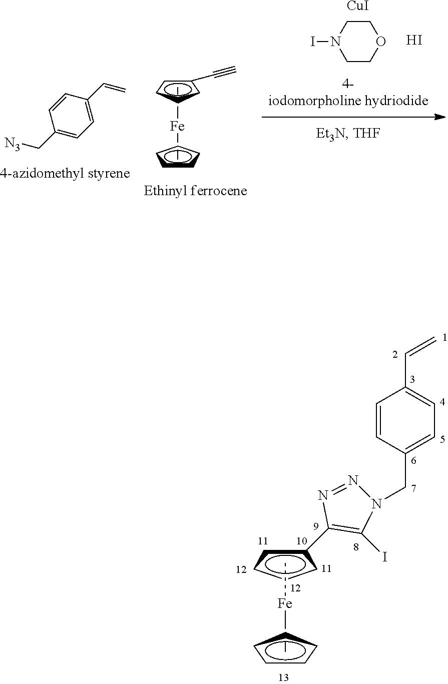

Synthesis of 5-iodo-4-ferrocenyl-1-(4-vinylbenzyl)-1H-1,2,3-triazole (FcTS-I). 1 g (4.76 mmol) Ethinyl ferrocene was mixed with 0.758 g (4.76 mmol) 1-(azidomethyl)-4-vinylbenzene, 1.79 g (5.24 mmol) 4-iodomorpholine-hydrogen iodide, and 1 wt % of butylated hydroxytoluene (BHT) as an inhibitor. The mixture was dissolved in 24 mL of THF, and the mixture was cooled in an ice bath. 0.907 g (4.76 mmol) CuI was slowly added under argon, followed by 0.80 mL (5.71 mmol) of Et₃N. The reaction mixture was stirred at room temperature overnight. Then the product was separated by flash chromatography on silica with toluene/ ethyl acetate eluent. The solvents were evaporated and the orange solid was dried under a vacuum. 474 mg (0.96 mmol, 20% yield) of FcTS-I was obtained.

¹H-NMR (500 MHz, C₃D₇NO) δ 7.55 (d, J=8.1 Hz, 2H, C5), 7.27 (d, J=8.0 Hz, 2H, C4), 6.78 (dd, J=17.6, 10.9 Hz, 1H, C2), 5.88 (dd, J=17.7, 1.0 Hz, 1H, C1), 5.77 (s, 2H, C7), 5.28 (dd, J=10.9, 1.0 Hz, 1H, C1), 5.02 (t, J=1.9 Hz, 2H, C11), 4.40 (t, 2H, C12), 4.13 (s, 5H, C13). ¹³C-NMR (125 MHz, C₃D₇NO) δ 150.41 (C9), 138.47 (C6), 137.43 (C2), 136.54 (C3), 128.75 (C4), 127.73 (C5), 115.53 (C1), 79.13 (C8), 76.82 (C10), 70.42 (C13), 69.73 (C12), 67.99 (C11), 54.36 (C7). HR-ESI (m/z): [M]+ calculated for C₂₁H1₈N₃FeI, 494.9895; found: 494.9898. Elemental analysis (%): calculated for C21H18N3FeI: C 50.94, H 3.66, N 8.49, I 25.63; found: C 51.20, H 3.84, N 8.24, I 25.12.

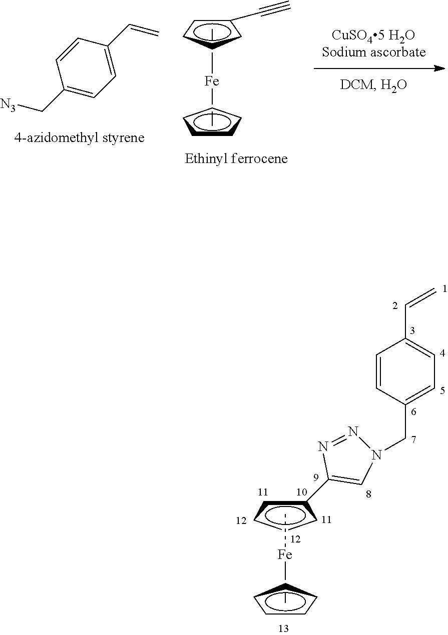

Synthesis of 4-ferrocenyl-1-(4-vinylbenzyl)-1H -1,2,3-triazole (FcTS). 1 g (4.76 mmol) Ethinyl ferrocene was mixed with 0.758 g (4.76 mmol)1-(azidomethyl)-4-vinylbenzene and 1 wt % of butylated hydroxytoluene (BHT) in 24 mL of DCM/H₂O (1:1 volume ratio). 0.424 g (2.16 mmol) sodium ascorbate, and 0.114 g (0.714 mmol) CuSO₄ were added to the mixture under argon. The reaction mixture was stirred at room temperature overnight. The reaction mixture was diluted with 140 mL of DCM/H₂O (1:1 volume ratio). Then the organic phase was separated and washed three times with water. The organic phase was dried over Na₂SO₄, and the solvent evaporated. The product was recrystallized from a DCM:hexane mixture, yielding 1.03 g (58%) of FcTS as an orange solid.

¹H-NMR (500 MHz, C₃D₇NO) δ 8.32 (s, 1H, C8), 7.55 (d, J=7.8 Hz, 2H, C5), 7.37 (d, J=7.7 Hz, 2H, C4), 6.79 (dd, J=17.7, 11.0 Hz, 1H, C2), 5.89 (d, J=17.6 Hz, 1H, C1), 5.69 (s, 2H, C7), 5.28 (d, J=10.9 Hz, 1H, C1), 4.77 (s, 2H, C11), 4.31 (s, 2H, C12), 4.04 (s, 5H, C13). ¹³C-NMR (125 MHz, C₃D₇NO) δ 147.60 (C9), 138.76 (C6), 137.71 (C2), 136.48 (C3), 129.48 (C4), 127.94 (C5), 122.00 (C8), 115.52 (C1), 77.81 (C10), 70.66 (C13), 69.66 (C12), 67.86 (C11), 54.21 (C7). HR-ESI (m/z): [M]+ calculated for C₂₁H1₉N₃Fe, 369.0922; found: 369.0928. Elemental analysis (%): calculated for C₂₁H1₉N₃Fe: C 68.31, H 5.19, N 11.38; found: C 67.58, H 5.61, N 10.17.

Polymerization of FcTS-I and FcTS. Both FcTS-I and FcTS were polymerized by free-radical polymerization. 4 mol % azobisisobutyronitrile (AiBN) was mixed with a 110 mM redox-active monomer solution in 1,4-Dioxane and DMF for FcTS-I and FcTS, respectively. The mixture was bubbled with argon for 15 min and heated to 60° C. for 16 h. The polymer was precipitated in ethyl ether. Then the polymer was separated from the solution mixture via centrifuge and dried under reduced pressure. Then the polymer was separated from the solution mixture via centrifuge. Relative molecular weight was analyzed by GPC shown in Table 2.

TABLE 2
Summary of polymer sizes measured by gel permeation chromatography
(GPC) with respect to the poly(methyl methacrylate)
in DMF with 14.5 mM LiBr as supporting salt.

| Polymer | Mₙ (g mol⁻¹) | M_{w} (g mol⁻¹) | Ð |
|---|---|---|---|
| P(FcTS-I) | 16,260 | 32,320 | 1.99 |
| P(FcTS) | 4,420 | 9,960 | 2.25 |

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

All publications, patents, and patent documents are incorporated by reference herein, as though individually incorporated by reference. No limitations inconsistent with this disclosure are to be understood therefrom. The invention has been described with reference to various specific and preferred embodiments and techniques. However, it should be understood that many variations and modifications may be made while remaining within the spirit and scope of the invention.

What is claimed is:

1. A metallopolymer comprising formula I: 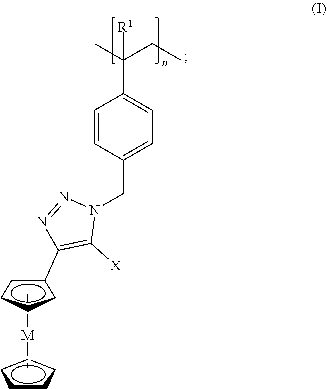
wherein,
M is a transition metal or transition metal ion;
R¹ is H or —(C₁-C₆)alkyl;
X is halo or H; and
n is an integer from about 10 to about 100,000; and
wherein the metallopolymer is redox-active.

2. The metallopolymer of claim 1 wherein M is iron metal (Fe) or an iron metal ion.

3. The metallopolymer of claim 1 wherein X is iodide or bromide.

4. The metallopolymer of claim 1 wherein R¹ is H or methyl.

5. The metallopolymer of claim 1 wherein the metallopolymer is P(FcTS-I): 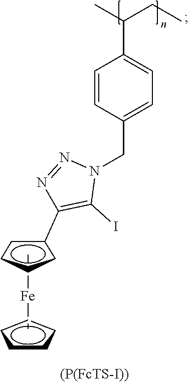
wherein n is an integer from about 10 to about 100,000.

6. The metallopolymer of claim 1 wherein the metallopolymer is P(FcTS): 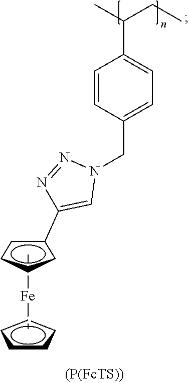
wherein n is an integer from about 10 to about 100,000.

7. The metallopolymer of claim 1 wherein n is about 25 to about 250.

8. A redox electrode comprising a metallopolymer according to claim 1, a carbon allotrope, and a crosslinker.

9. The redox electrode of claim 8 wherein the metallopolymer and the carbon allotrope have a mass ratio of about 0.25:1 to about 1:1.

10. The redox electrode of claim 8 wherein the carbon allotrope is a carbon nanotube.

11. The redox electrode of claim 8 wherein the crosslinker is 1,3-benzenedisulfonyl azide.

12. The redox electrode of claim 11 wherein the crosslinker is inserted via a nitrene into C—H bonds of the metallopolymer and the metallopolymer is crosslinked.

13. The redox electrode of claim 11 wherein the crosslinker has a wt. % of about 5% to about 20% in relation to the metallopolymer.

14. An electrochemical method for sensing or separating anions, comprising:
a) contacting a solution comprising a suitable solvent, a mixture of anions, and a redox electrode according to claim 8;
b) applying a voltage potential to the redox electrode wherein the voltage potential is applied under suitable conditions for chronoamperometry or voltammetry;
c1) sensing a target anion in the mixture via a change in voltage, current, or impedance relative to a reference electrode; and/or
c2) separating from the mixture a target anion;
wherein the redox electrode selectively binds to a target anion in the mixture thereby sensing the target anion in the mixture, separating the target anion from the mixture, or both.

15. The method of claim 14 wherein the applied voltage potential is sufficient to oxidize or reduce the metallopolymer of the redox electrode.

16. The method of claim 14 wherein the target anion is a halide or an oxyanion.

17. The method of claim 16 wherein the target anion is Cl⁻Br⁻, I⁻, HSO₄⁻, NO₃⁻ClO₄³¹ , PhSO₃⁻, or phHPO₃⁻.

18. The method of claim 14 wherein the redox electrode selectively binds to a target anion in the mixture.

19. The method of claim 14 wherein the metallopolymer of the redox electrode is poly(5-iodo-4-ferrocenyl-1-(4-vinylbenzyl)-1H-1,2,3-triazole) (P(FcTS-I)) or poly(4-ferrocenyl-1-(4-vinylbenzyl)-1H-1,2,3-triazol (P(FcTS)).

20. The method of claim 19 wherein the redox electrode selectively binds to a target anion via an electron depleted sigma hole in the halogen binding site of P(FcTS-I) when ferrocene (Fc) is oxidized to ferrocenium (Fc⁺) or via hydrogen bonding to P(FcTS) when Fc is oxidized to Fc⁺.
